(19) United States
(12) Patent Application Publication
(10) Pub. No.: US 2017/0037071 A1
(43) Pub. Date: Feb. 9, 2017

(54) MITOCHONDRIA-TARGETING PLATINUM(IV) PRODRUG

(71) Applicant: UNIVERSITY OF GEORGIA RESEARCH FOUNDATION, INC., Athens, GA (US)

(72) Inventors: Shanta Dhar, Miami, FL (US); Rakesh Pathak, Columbus, OH (US); Sean Marrache, Portland, OR (US)

(73) Assignee: University of Georgia Research Foundation, Inc., Athens, GA (US)

(21) Appl. No.: 15/302,549

(22) PCT Filed: Apr. 8, 2015
(86) PCT No.: PCT/US2015/024909

§ 371 Date: Oct. 7, 2016

Related U.S. Application Data
(63) Continuation-in-part of application No. PCT/US2015/018720, filed on Mar. 4, 2015.
Application No. PCT/US2015/018720 is a continuation-in-part of application No. PCT/US2014/069997, filed on Dec. 12, 2014.
(60) Provisional application No. 61/976,559, filed on Apr. 8, 2014.

(51) Int. Cl. C07F 15/00

(52) U.S. Cl. CPC C07F 15/0093

(57) ABSTRACT

Pt(IV) compounds include a mitochondria targeting moiety. One example of a Pt(IV) compound having a mitochondria targeting moiety is a Pt(IV) cisplatin-based compound. Upon reduction, the mitochondrial targeting moieties are released resulting in a Pt(II) therapeutic agent. Pt(IV) compounds including a mitochondria targeting moiety can be included in nanoparticles. The compounds or nanoparticles can be used to treat, for example, cancer.

### RELATED APPLICATION

This application claims the benefit of (i) U.S. Provisional Patent Application No. 61/976,559 filed on Apr. 8, 2014, (ii) PCT Patent Application PCT/US2014/069997, filed on Dec. 12, 2014; and (iii) PCT Patent Application PCT/US2015/018720, filed on Mar. 4, 2015, which applications are hereby incorporated herein by reference.

### STATEMENT OF GOVERNMENTAL SUPPORT

This invention was made with government support under grant number P30GM092378, awarded by the National Institutes of Health. The government has certain rights in the invention.

### FIELD

The present disclosure relates to targeting platinum-containing therapeutic agents to mitochondria in the form of prodrugs using mitochondria targeted small molecules, targeted nanoparticles, or both mitochondria targeted small molecules and targeted nanoparticles; and methods of use and manufacture thereof

### BACKGROUND

Resistance to cisplatin or other anticancer agents can result from several mechanisms, including decreased uptake and accelerated DNA repair by nucleotide excision repair (NER) machinery. A need exists to develop alternative or improved anticancer agents or prodrugs.

### SUMMARY

This disclosure relates to, among other things, synthesis and characterization of platinum-containing prodrugs bearing mitochondria targeted moieties and nanoparticles that include platinum-containing prodrugs bearing mitochondria targeted moieties.

The prodrugs and nanoparticle formulations described herein, among other things, were devised to circumvent the resistance in certain cancer types through acting on mitochondrial DNA. Mitochondrial DNA (mtDNA) plays significant roles in cell death and metastatic competence. The close proximity of mtDNA to the reactive oxygen species (ROS) production site makes this genome vulnerable to oxidative damage, which account for increased mtDNA mutations often observed in cancer. Mitochondrial dysfunction and associated mtDNA depletion reversibly regulate epigenetic modification in the nucleus that contributes to cancer development. Thus targeting mtDNA could lead to novel and effective therapies for aggressive cancer. In addition, the lack of NER in the mitochondria and enhanced mitochondrial DNA (mtDNA) mutation in aggressive cancer may allow cisplatin that is directed inside the mitochondrial matrix to provide an effective therapeutic option.

In some embodiments described herein, a compound includes a Pt(IV) prodrug and one or more mitochondria targeting moiety conjugated to the Pt(IV) prodrug. On reducing to Pt(II) the one or more mitochondria targeting moieties are released and a Pt(II) therapeutic agent results.

In embodiments described herein, a compound, which may be a prodrug, has the following structure:

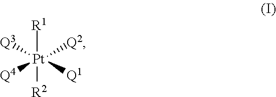

where:
each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five-or six-membered platinocyclic rings (e.g., monocyclic rings, bicyclic rings, tricyclic rings, and the like);
R¹ is -(L¹)ₘ—(R³).;
R² is OH or -(L²)ₓ—(R⁴)_{y};
R³ is a mitochondria targeting moiety;
R⁴ is a conjugated cyclooxygenase inhibitor, a targeting moiety, a fluorophore, a glycolysis inhibitor, or a mitochondria acting therapeutic agent, wherein if R⁴ is a mitochondria targeting moiety, R³ and R⁴ are the same or different;
L¹ is a linker;
L² is a linker, wherein L¹ and L², if both are present, are the same or different;
m and x are independently zero or one; and
n and y are independently an integer greater than or equal to 1.

In some embodiments, when m=0, n=1 and when x=0, y=1.

In some embodiments described herein, a compound, which may be a prodrug, has one of the following structures:

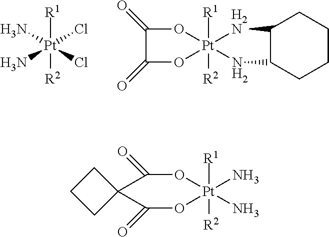

where R¹ and R² are as defined above with regard to a compound of Formula (I).

In some embodiments a Pt(IV) prodrug is Platin-M, having the following formula:

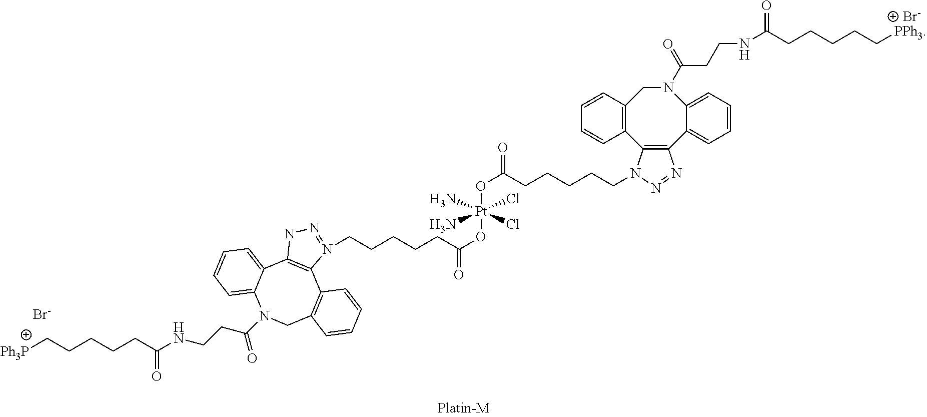

In this case R¹ and R² each comprise a triphenyl phosophonium (TPP) containing mitochondria targeting moiety. Of course, one or both of R¹ and R² may comprise other mitochondria targeting moieties, such as rhodamine cations, Szeto-Shiller peptides, and the like.

In some embodiments, a Pt(IV) prodrug having one or more mitochondria targeting moieties is included in a nanoparticle. In some embodiments, the nanoparticle includes a mitochondria targeting moiety or a disease targeting moiety, such as a cancer targeting moiety.

A compound or nanoparticle described herein may be used for treating cancer or a mitochondrial disease in a patient in need thereof In some embodiments, a compound or nanoparticle described herein is used to treat cisplatin resistant cancer.

In some embodiments, a compound or nanoparticle described herein may be used to treat a disease of a central nervous system (CNS) of a subject. In various embodiments, a compound or nanoparticle described herein is used to treat a disease of a brain of a subject. The mitochondria-targeted compounds or nanoparticles described herein may accumulate in the CNS (e.g., the brain). The accumulation in the CNS may result from systemic administration (e.g., oral, IV, IM, IP, etc. administration, as opposed to direct administration—which may also be employed).

Advantages of one or more of the various embodiments presented herein over therapies, therapeutic agents and methods will be readily apparent to those of skill in the art based on the following detailed description when read in conjunction with the accompanying drawings.

### BRIEF DESCRIPTION OF THE DRAWINGS

FIG. 1. Schematic figure for delivery of cisplatin prodrug inside the mitochondria using a targeted delivery vehicle and the mechanism of action.

FIG. 2. Synthesis of mitochondria targeted Pt(IV) prodrug cisplatin and its NPs.

FIG. 3. (A) Distribution of PLGA_{HMW}-b-PEG-TPP and PLGA_{LMW}-b-PEG-TPP-NPs in the different mitochondrial compartments of PC3 cells by ICP-MS (top) and IVIS analysis (bottom). (B) (Left) Size and zeta potential of targeted and non-targeted HDL-mimicking NPs with or without QD and (Right) TEM images of targeted and non-targeted QD-loaded HDL-mimicking NPs. (B) Mitochondrial toxicity of PLGA_{LMW}-b-PEG-TPP-NPs on PC3 and cisplatin resistant A2780/CP70 cells by XF24 mitostress assay. (C) Variation of Cd concentration in ng/mL in plasma with time, PK parameters, tissue distribution, and cumulative excretion profiles following the administration of T-QD-NPs intravenously to male rats.

FIG. 4. (A) Size, zeta potential, % loading, % EE, and TEM images of T-Platin-M and NT-Platin-MNPs. (B) Release kinetics of Platin-M from T and NT-NPs in PBS at 37° C. (C) Distribution of cisplatin, Platin-M, NT-Platin-M-NPs, and T-Platin-M-NPs in cytosolic, nuclear, and mitochondrial fractions of PC3 cells. (C) Comparison of Pt-nDNA and Pt-mtDNA adducts for cisplatin, Platin-M, NTPlatin-M-NP, and T-Platin-M-NPs in PC3 cells.

FIG. 5. Mitochondrial bioenergetics analyses in PC3, SH-SY5Y, and A2780/CP70 cell lines in response to cisplatin, Platin-M, NT-Platin-M-NPs, and T-Platin-M-NPs. A representative graph of OCR output from XF24 analyzer of control, cisplatin, Platin-M, NT-Platin-M-NPs, and T-Platin-M-NPs treated PC3, SH-SY5Y, and A2780/CP70 cells and its response to oligomycin, FCCP, antimycin A/rotenone and comparison of spare respiratory capacity, coupling efficiency, basal respiration, and ETC accelerator response, and ATP coupler response in the treated cells.

FIG. 6. Mitochondrial bioenergetics in two canine brain tumor cell lines in response to 24 h treatment of cisplatin or Platin-M or NT-Platn-M-NP or T-Platin-M-NPs (10 μM with respect to cisplatin or Platin-M) measured as a function of oxygen consumption rate (OCR). Mean values plotted, n=4, error bars present SD.

FIG. 7. In vitro efficacy of T-Platin-M-NPs and comparison with cisplatin, carboplatin, Platin-M, and NT-Platin-M-NPs in canine brain tumor cell line SDT3G. Cell viability was assessed by the MTT assay after treatment with the indicated concentrations of the test articles for 48 or 72 h. For all NP treatments, media was changed after 12 h and cells were further incubated for 36 or 60 h. The data are mean ±SD (n=3 wells). The IC50 values are presented as average from three independent experiments.

FIG. 8. (A) Study design for biodistribution and safety study in beagle dogs. (B) Platinum concentration in organs 14 days after single intravenous injection of T-Platin-MNP (0.5 mg/kg with respect to Platin-M) in two beagles and representative images fro Day 14 post-injection histopathology of cerebellum, cerebrum, heart, lung, liver, kidney, and spleen. No changes related to the T-Platin-M-NPs injection were observed. (C) Blood urea nitrogen (BUN), creatinine, and alanine aminotransferase (ALT) values for both dogs remained within clinically acceptable limits for the duration of the study.

FIG. 9. Complete clinical chemistry and some hematology data from safety and bioD studies with T-Platin-M-NPs with a dose of 0.5 mg/kg in two female dogs for a period of 14 days.

FIG. 10. (A) Complete serum chemistry results predose, day 1, day 7, and day 14 after single intravenous injection of T-Platin-M-NPs with 2 mg/kg in two male beagles. (B) BUN, creatinine, and ALT values for both dogs during the period of this study. (C) The white blood cell (WBC) and platelet counts from the two beagles during the course of the study. L: Low.

FIG. 11. (A) Complete serum chemistry results predose, day 1, day 7, and day 14 after single intravenous injection of T-Platin-M-NPs with 2.2 mg/kg in two male beagles. (B) BUN, creatinine, and ALT values for both dogs during the period of this study. (C) WBC and platelet counts from the two beagles during the course of the study. H: High.

The schematic drawings in are not necessarily to scale.

### DETAILED DESCRIPTION

A mitochondria-targeted cisplatin prodrug, Platin-M, was constructed using a strain promoted alkyne azide cycloaddition chemistry. Efficient delivery of Platin-M using a biocompatible polymeric nanoparticle (NP) based on biodegradable poly(lactic-co-glycolic acid) (PLGA)-block (b)-polyethyleneglycol (PEG) functionalized with a terminal triphenylphosphonium (TPP) cation which has remarkable activity to target mitochondria of cells resulted in controlled release of cisplatin from Platin-M locally inside the mitochondrial matrix to attack mutated mitochondrial DNA (mtDNA) and exhibited otherwise resistant advance cancer sensitive to cisplatin-based chemotherapy. Identification of an optimized targeted-NP formulation with brain-penetrating properties allowed for delivery of Platin-M inside the mitochondria of neuroblastoma cells resulting in ˜18 times more activity than cisplatin. The remarkable activity of Platin-M and its targeted-NP in cisplatin resistance cells was correlated with the hyperpolarization of mitochondria in these cells and further supported the hypothesis via mitochondrial bioenergetics studies in the resistance cells. This unique approach to controlled delivery of cisplatin in the form of a prodrug to the mitochondria to attack the mitochondrial genome lacking NER machinery and in vivo distribution properties of the delivery vehicle in the brain suggested previously undescribed routes for cisplatin-based therapy on treatment of neuroblastoma.

The cellular powerhouse, mitochondria are implicated in the process of carcinogenesis because of their vital role in energy production and apoptosis. Mitochondria are the key players in generating the cellular energy through oxidative phosphorylation (OXPHOS) that produces reactive oxygen species (ROS) as by-products. Mitochondrial DNA (mtDNA) plays significant roles in cell death and metastatic competence. The close proximity of mtDNA to the ROS production site makes this genome vulnerable to oxidative damage, which account for increased mtDNA mutations often observed in cancer. Mitochondrial dysfunction and associated mtDNA depletion possibly reversibly regulate epigenetic modification in the nucleus that contributes to cancer development. Thus targeting mtDNA could lead to novel and effective therapies for aggressive cancer.

Cisplatin, a widely used and the Food and Drug Administration (FDA) approved chemotherapeutic agent, is highly effective against several cancers, including testicular, breast, ovarian, bladder, and lung cancers. The compounds and nanoparticles described herein may thus also be used to treat a variety of cancers, including those for which cisplatin are used.

Cisplatin is most extensively characterized as a DNA-damaging agent, and the cytotoxicity of cisplatin is attributed to the ability to form interstrand and intrastrand nuclear DNA (nDNA) cross-links. The nucleotide excision repair (NER) pathway plays a major role in repairing cisplatin-nDNA adducts. Cells with compromised NER machinery are often sensitive to cisplatin treatment. Resistance to cisplatin can result from several mechanisms, including decreased uptake and accelerated DNA repair by NER machinery. Limited studies have examined cisplatin activity on mtDNA of cancer cells. Indeed, mtDNA is significantly more sensitive than nDNA to the damage induced by a range of agents. The lack of NER in the mitochondria and enhanced mtDNA mutation in aggressive cancer gives a strong rationale in directing cisplatin in the form of a prodrug inside the mitochondrial matrix of cancer cells to provide an effective therapeutic option.

Only a limited number of studies investigated activity of cisplatin on mtDNA with conflicting data. Cells depleted of mtDNA show significant resistance to chemotherapeutic agents. Cisplatin-induced mitochondrial damage was linked to cisplatin mediated gastrointestinal toxicity, ototoxicity, and nephrotoxicity. However, an important step to target the mtDNA by cisplatin to overcome resistance or to understand cisplatin-induced mitochondrial toxicity require a mitochondria-targeted prodrug and even better an optimal drug delivery system that is able to reach the innermost mitochondrial space, the mitochondrial matrix, where the mtDNA is located.

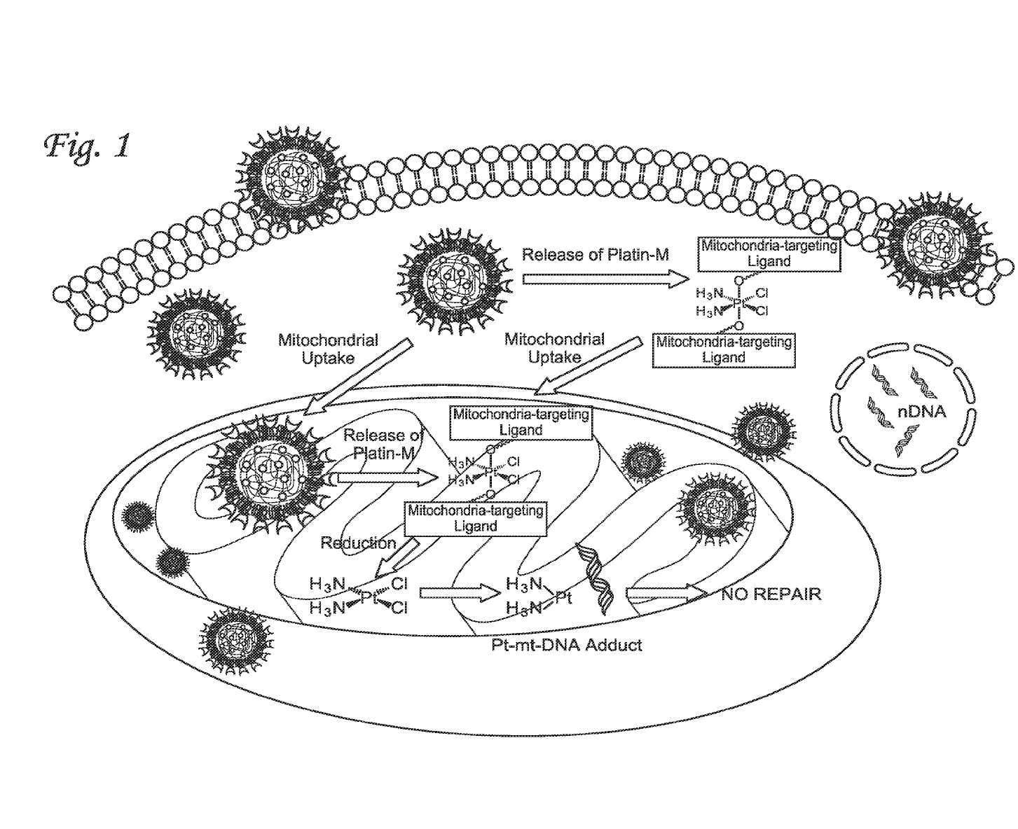

We recently developed a biocompatible polymeric nanoparticle (NP) based on biodegradable poly(lactic-co-glycolic acid) (PLGA)-block (b)-polyethyleneglycol (PEG) functionalized with a terminal triphenylphosphonium (TPP) cation which has remarkable activity to target mitochondria of cells due to its high lipophilic properties, presence of positive charge, and appropriate size range. We identified an optimized NP formulation of suitable diameter and surface charge for efficient mitochondria targeting and maximum mitochondrial matrix accumulation. Here, we describe construction of a hydrophobic mitochondria targeted cisplatin prodrug, Platin-M, using a strain promoted alkyne azide cycloaddition (SPAAC) chemistry and its delivery using PLGAb-PEG-TPP NPs to release cisplatin locally inside the mitochondrial matrix to attack mutated mtDNA which may make otherwise resistant advanced cancer sensitive to cisplatin based chemotherapy (FIG. 1).

Higher concentrations of the drug and its nanoparticles may exhibit some toxicity because of the presence of DBCO and TPP moieties. However, it can be solved by using less concentrations and also modifying the molecule from two targeting moieties to one.

These results serve as the basis for development of other Pt(IV) prodrugs having one or more mitochondria targeting moiety or nanoparticles including such prodrugs.

A. Pt(IV) Prodrugs

A compound as described herein may be any Pt(IV) prodrug that comprises one or more mitochondria targeting moieties. When the compound is reduced, the one or more mitochondria targeting moieties can be released and a platinum (II) therapeutic agent can result.

Any platinum therapeutic agent may be employed. Preferably the platinum therapeutic agent is a Pt(II) therapeutic agent, where axial positions can be installed.

In some embodiments, a Pt(IV) prodrug has a structure as follows

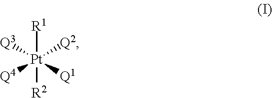

where:
each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five-or six-membered platinocyclic rings (e.g., monocyclic rings, bicyclic rings, tricyclic rings, and the like);
R¹ is -(L¹)ₘ—(R³)ₙ;
R² is OH or -(L²)ₓ—(R⁴)_{y};
R³ is a mitochondria targeting moiety;
R⁴ is a conjugated cyclooxygenase inhibitor, a targeting moiety, a fluorophore, a glycolysis inhibitor, or a mitochondria acting therapeutic agent, wherein if R⁴ is a mitochondria targeting moiety, R³ and R⁴ are the same or different;
L¹ is a linker;
L² is a linker, wherein L¹ and L², if both are present, are the same or different;
m and x are independently zero or one; and
n and y are independently an integer greater than or equal to 1.

In some embodiments, when m=0, n=1 and when x=0, y=1.

In some embodiments, n and y of Formula I (or Formula IV, V, VI or VII as described below) are, each independently, an integer from 1 to 8, such as an integer from 1 to 4. The linkers, L¹ and L², if employed, can be selected to control the number of moieties of R³ and R⁴ present in the compound of Formula I. That is, the linkers, L¹ and L², can determine the value of n and y.

For embodiments in which two of Q¹, Q², Q³, and Q⁴ represent negatively charged ligands, the resulting platinum(IV) compound is neutral. For embodiments in which only one of Q¹, Q², Q³, and Q⁴ represents a negatively charged ligand, the platinum of the resulting platinum(IV) compound bears a single positive charge (+1), and the platinum (IV) compound is a salt that includes a negatively charged (−1) counterion (e.g., NO₃⁻, HSO₄⁻, and the like). For embodiments in which none of Q¹, Q², Q³, and Q⁴ represents a negatively charged ligand, the platinum of the resulting platinum(IV) compound bears a positive charge of +2, and the platinum (IV) compound is a salt that includes a counter ion having a charge of −2 (e.g., SO₄⁻², and the like), or two single negatively charged (−1) counterions (e.g., NO₃⁻, HSO₄⁻, combinations thereof, and the like).

A wide variety of negatively charged ligands can be useful, including, for example, those known as negatively charged ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary negatively charged ligands include, for example, halides (e.g., Cl⁻, Br⁻, etc.), alkoxides and aryloxides (e.g., RO⁻), carboxylates (e.g., RC(O)O⁻), sulfates (e.g., RSO₄⁻), and the like, wherein each R individually represents H or an organic group.

A wide variety of neutral ligands can be useful, including, for example, those known as neutral ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary neutral ligands include, for example, R⁵N, wherein each R individually represents H or an organic group, wherein two or more R groups can optionally be joined to form one or more rings; and nitrogen-containing heteroaromatics (e.g., pyridine, quinoline, phenanthridine, and the like).

In some embodiments, two negatively charged ligands; two or more neutral ligands; and/or two or more neutral and negatively charged ligands may be combined to form bidentate ligands, tridentate ligands, or tetradentate ligands.

In some embodiments, a Pt(IV) prodrug has a structure as follows

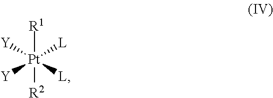

where:
R¹ and R² are as defined above with regard to a compound of Formula (I); and
each Y independently represents a negatively charged ligand, wherein both Y ligands may optionally be joined to form a five- or six-membered platinocyclic ring; each L independently represents a neutral ligand, wherein both L ligands may optionally be joined to form a five- or six-membered platinocyclic ring.

In some embodiments, a Pt(IV) prodrug has a structure as follows:

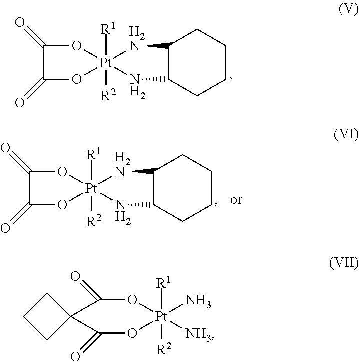

where R¹ and R² are as defined above with regard to compounds of Formula (I).

In various embodiments, R⁴ is of a compound according to Formula I, IV, V, VI or VII is a conjugated cyclooxygenase inhibitor. R⁴ can be any suitable conjugated cyclooxygenase inhibitor. Examples of suitable conjugated cyclooxygenase inhibitors are included in PCT patent application, PCT patent application PCT/US2014/06999 filed Dec. 12, 2014 and entitled PRODRUG FOR RELEASE OF CISPLATIN AND CYCLOOXYGENASE INHIBITOR, which claims the benefit of U.S. Provisional Patent Application No. 61/915,110 filed on Dec. 12, 2013, which patent applications are hereby incorporated herein by reference in their entireties to the extent that they do not conflict with the disclosure presented herein.

Examples of suitable cyclooxygenase inhibitors that can be conjugated to a Pt of a PT(IV) compound or to a linker conjugated to a Pt(IV) compound include nonsteroidal anti-inflammatory drugs (NSAIDs). Examples of suitable NSAIDs include aspirin, salicylates (e.g., sodium, magnesium, choline), celecoxib, diclofenac potassium, diclofenac sodium, diflunisal, etodolac, fenoprofen calcium, flurbiprofen, ibuprofen, indomethacin, ketoprofen, meclofenamate sodium, mefenamic acid, meloxicam, nabumetone, naproxen, naproxen sodium, oxaprozin, piroxicam, rofecoxib, salsalate, sulindac, tolmetin sodium, valdecoxib, and the like. In some embodiments, a compound according to Formula I includes one of more of the following conjugated cyclooxygenase inhibitors, which are releasable in a pharmaceutically active form: aspirin (acetyl salicylic acid); salicylic acid; Sulindac Sulfone ((Z)-5-Fluoro-2-methyl-1[p-(methylsulfonyl) benzylidene]indene-3-acetic Acid); Sulindac Sulfide ((Z)-5-Fluoro-2-methyl-1-[p-(methylthio)benzylidene]indene-3-acetic Acid); SC-560 (5-(4-Chlorophenyl)-1-(4-methoxyphenyl)-3-trifluoromethylpyrazole); Resveratrol (trans-3,4,5-Trihydroxystilbene); Pterostilbene succinate, ((E)-4-(4-(3,5-dimethoxystyryl)phenoxy)-4-oxobutanoic acid); Meloxicam (4((2-methyl-3-((5-methylthiazol-2-yl)carbamoyl)-1,1-dioxido-2H-benzo[e][1,2]thiazin-4-yl)oxy)-4-oxobutanoic acid); Indomethacin Ester, 4-Methoxyphenyl-(1-(p-Chlorobenzoyl)-5-methoxy-2-methyl-1H-indole-3-acetic Acid, 4-Methoxyphenyl Ester; Indomethacin 1-(p-Chlorobenzoyl)-5-methoxy-2-methyl-1H-indole-3-acetic Acid; Ibuprofen; Flurbiprofen (±)-2-Fluoro-a-methyl[1,1′-biphenyl]-4-acetic Acid); Diclofenac Sodium (2-[(2,6-Dichlorophenyl)amino]benzeneacetic Acid, Sodium); Diclofenac, 4′-Hydroxy-(2-[((2′, 6′-Dichloro-4′-hydroxy) phenyl)amino]benzeneacetic Acid) and COX-2 Inhibitor I (Methyl [5-methylsulfonyl-1-(4-chlorobenzyl)-1H-2-indolyl]carboxylate).

In various embodiments, R⁴ is of a compound according to Formula I, IV, V, VI or VII is a conjugated mitochondria acting therapeutic agent. Examples of suitable mitochondria acting therapeutic agents include rotenone, annonaceous acerogenins, α-tocopherylsuccinate, metformin, myxothiazole A, antimycin A_{3b}, oligomycin C, apoptolidin A, Bz-423, resveratrol, diindoyl-methane, PK11195, aurovertin B, R207910, elesclomol, 2-methoxyestradiol, MitoQ, F16, MKT-077, and the like.

In various embodiments, R⁴ is of a compound according to Formula I, IV, V, VI or VII is a fluorophore. Any suitable fluorophore can be employed. For example, a fluorophore can be a fluorescent protein or a non-protein organic fluorophore. Examples of non-protein organic fluorophores include xanthene derivatives, cyanine derivatives, squaraine derivatives and ring-substituted squaraines, naphthalene derivatives, coumarin derivatives, oxadiazole derivatives, anthracene derivatives, pyrene derivatives, oxazine derivatives, acridine derivatives, arylmethine derivatives, and tetrapyrrole derivatives. Examples of xanthene derivatives include fluorescein, rhodamine, Oregon green, eosin, and Texas red. Examples of cyanine derivatives include cyanine, indocarbocyanine, oxacarbocyanine, thiacarbocyanine, and merocyanine. Examples of squaraine derivatives and ring-substituted squaraines include Seta, SeTau, and Square dyes. Examples of naphthalene derivatives include dansyl and prodan derivatives. Examples of oxadiazole derivatives include pyridyloxazole, nitrobenzoxadiazole and benzoxadiazole. Examples of anthracene derivatives include anthraquinones, including DRAQ5, DRAQ7 and CyTRAK Orange. Examples of pyrene derivatives include cascade blue and the like. Examples of oxazine derivatives include Nile red, Nile blue, cresyl violet, oxazine 170 and the like. Examples of acridine derivatives include proflavin, acridine orange, acridine yellow and the like. Examples of arylmethine derivatives include auramine, crystal violet, and malachite green. Examples of tetrapyrrole derivatives include porphin, phthalocyanine, and bilirubin

In various embodiments, R⁴ is of a compound according to Formula I, IV, V, VI or VII is a glycolysis inhibitor. Any compound that inhibits one or more glycolysis enzyme can be employed. Examples of glycolysis inhibitors include 2-deoxyglucose, lonidamine, 3-bromopyruvate, imatinib, and oxythiamine.

In various embodiments, R⁴ is of a compound according to Formula I, IV, V, VI or VII is a targeting moiety. Any suitable targeting moiety can be used in accordance with the teachings presented herein. As used herein, a “targeting moiety” is a moiety that increases the concentration of a compound in or near a tissue, cell, etc. of interest when the molecule is introduced into a subject, relative to a compound that lacks the targeting moiety. A targeting moiety can be conjugated to Pt of a Pt(IV) compound or to a linker that is conjugated to Pt of a Pt(IV) compound.

A targeting moiety can be, for example, a disease targeting moiety, such as a cancer targeting moiety, or a mitochondria targeting moiety. Any suitable cancer targeting moiety may be attached to a nanoparticle described herein. Examples of cancer targeting moieties include moieties that bind cell surface antigens or markers that are selective to cancer cells or over-expressed, up-regulated or otherwise present in amounts not found in non-cancer cells.

In various embodiments, R⁴ is of a compound according to Formula I, IV, V, VI or VII is a mitochondrial targeting moiety. The targeting moiety of R⁴ can be the same or different from the targeting moiety of R³. Any suitable mitochondria targeting moiety may be employed. Due to the substantial negative electrochemical potential maintained across the inner mitochondrial membrane, delocalized lipophilic cations are effective at crossing the hydrophobic membranes and accumulating in the mitochondrial matrix. Triphenyl phosophonium (TPP) containing moieties can be used to concentrate compounds in the mitochondrial matrix. Any suitable TPP-containing compound may be used as a mitochondrial matrix targeting moiety. Representative examples of TPP-based moieties may have structures indicated below in Formula IX, Formula X or Formula XI:

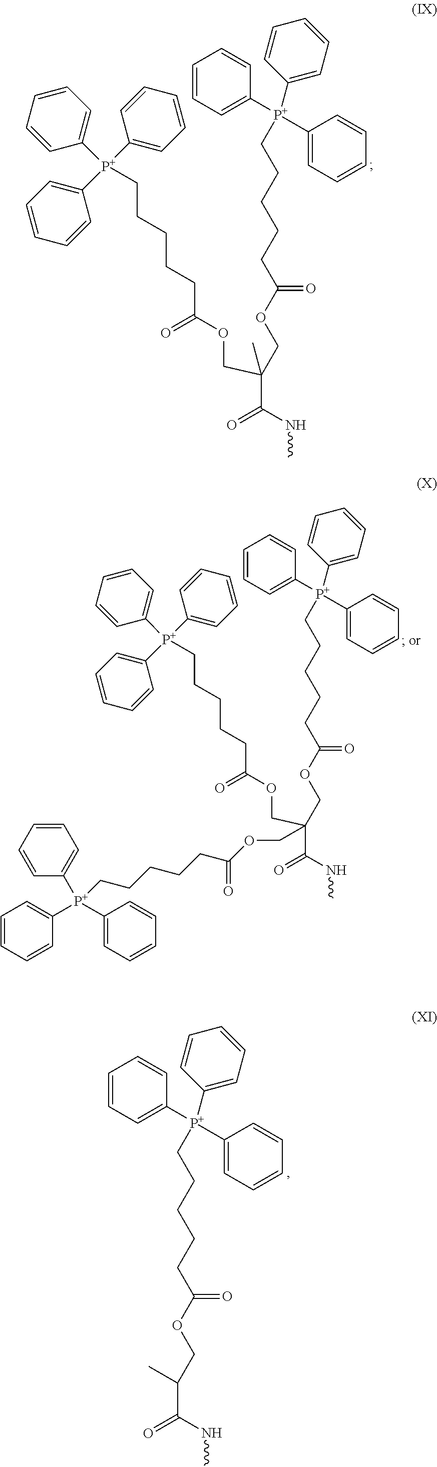

where the amine (as depicted) may be conjugated to a linker that is conjugated to the Pt(IV) of a compound according to Formula I. Of course conjugation can be accomplished via other groups of a compound according to Formula IX, X, or XI.

In some embodiments, the delocalized lipophilic cation for targeting the mitochondrial matrix is a rhodamine cation, such as Rhodamine 123 having Formula XII as depicted below:

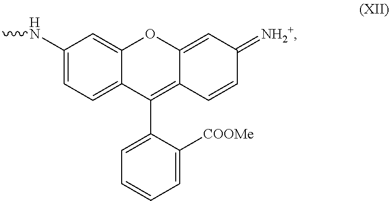

where the secondary amine (as depicted) may be conjugated to a linker that is conjugated to the Pt(IV) of a compound according to Formula I. Of course conjugation can be accomplished via another group of a compound according to Formula XII.

Of course, non-cationic compounds may serve to target and accumulate in the mitochondrial matrix. By way of example, Szeto-Shiller peptide may serve to target and accumulate a nanoparticle in the mitochondrial matrix. Any suitable Szetto-Shiller peptide may be employed as a mitochondrial matrix targeting moiety. Non-limiting examples of suitable Szeto-Shiller peptides include SS-02 and SS-31, having Formula XIII and Formula XIV, respectively, as depicted below:

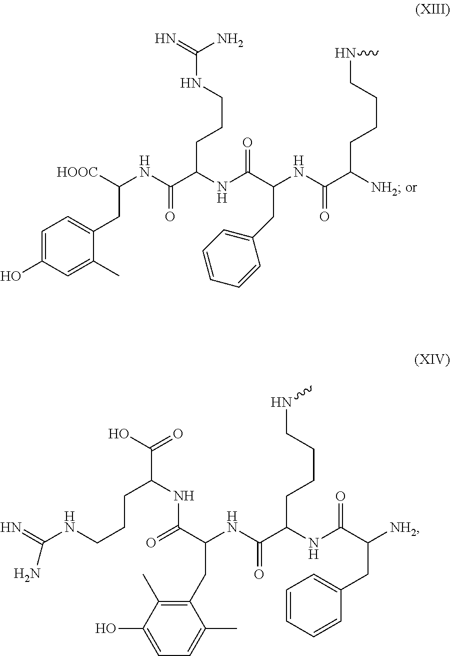

where the secondary amine (as depicted) may be conjugated to a linker that is conjugated to the Pt(IV) of a compound according to Formula I. Of course conjugation can be accomplished via other groups of a compound according to Formula XII or XIV.

The targeting moieties may be modified as appropriate to incorporate into the Pt(IV) compounds described herein. For example, the targeting moieties may be modified to be suitable for click chemistry as described in, for example, PCT patent application PCT/US2014/06999 filed Dec. 12, 2014 and entitled PRODRUG FOR RELEASE OF CISPLATIN AND CYCLOOXYGENASE INHIBITOR, and U.S. Provisional Patent Application No. 61/915,110 filed on Dec. 12, 2013.

In some embodiments, a mitochondria targeting moiety may be conjugated to a dibenozyzlooztyne (DBCO) derivative or another cyclooctyne derivative, such as those cyclooctynes known to those of skill in the art, to result in a DBCO-mitochondria targeting moiety or cyclooctyne-mitochondria targeting moiety for incorporation into a Pt(IV) compound according to the present disclosure.

In some embodiments, a Pt(IV) prodrug is Platin-M, having the following formula:

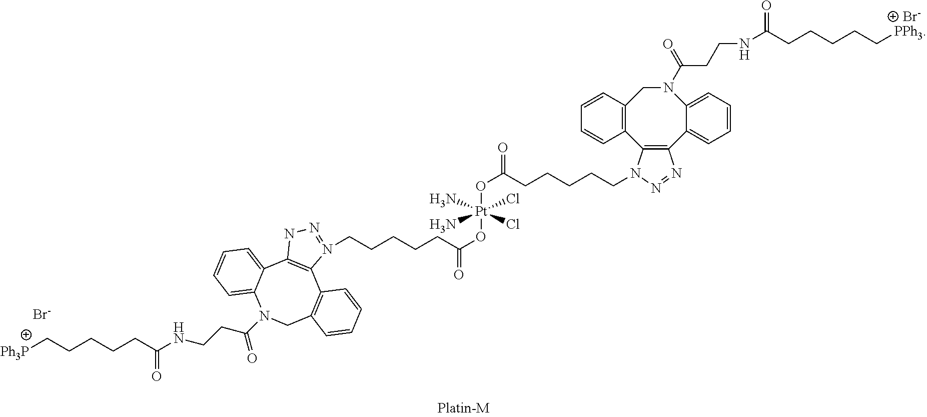

In this case mitochondria targeting moieties comprise a triphenyl phosophonium (TPP) moiety.

Click chemistry can be employed to conjugate a targeting moiety or a linker to which one or more cyclooxygenase inhibitors, targeting moieties, or the like are attached to a Pt(IV) compound. Examples of click chemistry techniques that can be employed to produce Pt(IV) compounds according to the present disclosure are described in, for example, PCT patent application PCT/US2015/018720 filed on Mar. 4, 2015 and entitled PLATINUM(IV) COMPOUNDS AND METHODS OF MAKING AND USING SAME and U.S. Provisional Patent Application No. 61/947,703 filed on Mar. 4, 2015, which applications are hereby incorporated herein in their entireties to the extent that they do not conflict with the present disclosure. More generally, examples of suitable click chemistry techniques include copper-catalyzed azide-alkyne cycloaddition (CuAAC), strain promoted alkyne cycloaddition (SPAAC) and the like. Azide functionality can readily be added to an Pt(IV) compound, such as c,c,t [PtCl₂(NH₃)₂(OH)₂], by reacting the Pt(IV) compound with a azide anhydride as, for example, shown below:

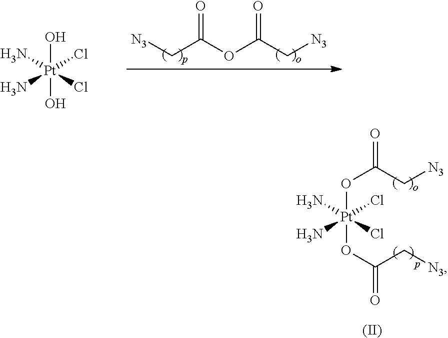

where o and p are independently 0 to 10, such as 3 to 7 or, for example, 5. In some embodiments, o and p are the same. In some embodiments the azide anhydride is 6-azidohexanoic anhydride. In some embodiments, only one azide moiety is added to the resulting Pt compound by limiting the concentration of the azide anhydride or blocking one of the hydroxyl groups. Any suitable solvent can be used. Examples of suitable solvents include dimethyl sulfoxide (DMSO), dimethyl formamide (DMF), and the like. c,c,t [PtCl₂(NH₃)₂(OH)₂] can be synthesized in any suitable manner, such as reacting Cisdiamminedichloridoplatinum(II) (cisplatin) with hydrogen peroxide.

An azide functionalized Pt(IV) compound, such as a compound according to Formula II as described above, can then be reacted with an alkyne-containing linker, which can optionally contain one or more conjugated cyclooxygenase inhibitors, targeting moieties, or the like. If the alkyne-containing linker does not contain, for example, one or more conjugated cyclooxygenase inhibitors or targeting moieties, such moieties can be conjugated to the linker after the linker is reacted with the azide-functionalized Pt(IV) compound.

As indicated above, CuAAC, SPAAC, or any other suitable form of click chemistry can be employed. Examples of SPAAC alkyne-containing compounds that can include or can be modified to include a cyclooxygenase inhibitor, a targeting moiety, or the like are described in, for example, U.S. Pat. No. 8,133,515, entitled ALKYNES AND METHODS OF REACTING ALKYNES WITH 1,3-DIPOLE-FUNCTIONAL COMPOUNDS, and U.S. Provisional Patent Application No. 61/947,703, filed Mar. 4, 2014, entitled STRAIN PROMOTED AZIDE ALKYNE CYCLOADDITION REACTION ON PT(IV) SCAFFOLD: A VERSATILE BIOORTHOGONAL APPROACH TO FUNCTIONALIZE CISPLATIN PRODRUGS, which patent and patent application are each hereby incorporated herein by reference in their respective entireties to the extent that they do not conflict with the present disclosure.

For purposes of illustration, SPAAC reaction of functionalized azadibenzocyclooctyne (ADIBO) derivatives with an azide functionalized Pt(IV) compound according to Formula II is shown below.

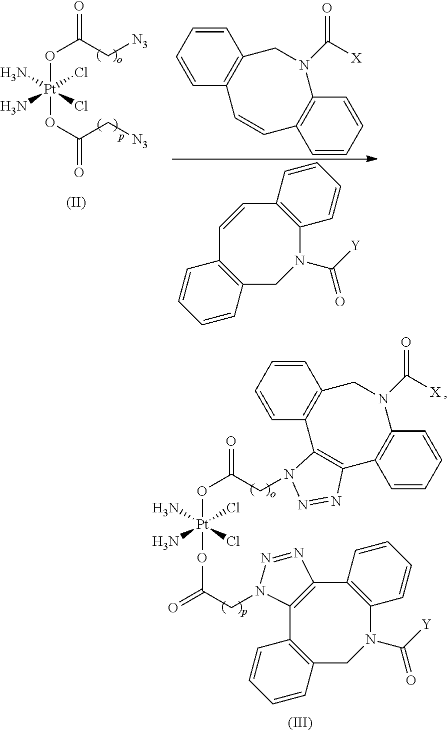

where o and p are as defined above with regard to a compound according to Formula II, where X is R³ or -linker-R³ or a functional group to which R³ or -linker-R³ can be conjugated, and where Y is R⁴ or -linker-R⁴ or a functional group to which R³ or -linker-R³ can be conjugated. R³ and R⁴ are as defined above with regard to a compound according to Formula I (or IV, V, VI, or VII). The linker of X and Y, if present, can independently be any suitable linker to which R³ or R⁴ can be bound. In some embodiments, the linker comprises a cleavable linker. A cleavable linker can provide controllable release of, for example, a cyclooxygenase inhibitor (e.g. R⁴, when R⁴ is a cyclooxygenase inhibitor). Any suitable cleavable linker can be employed. Examples of suitable cleavable linkers include those presented in FIG. 12 of U.S. Pat. No. 8,133,515, such as disulfide linkers, oxime linkers, hydrazine linkers, diazo linkers, carbonyloxyethylsulfone linkers, amino acid linkers, phenylacetamide linkers, and the like. The linker can be chosen to facilitate release of R³ or R⁴, as the case may be, in an environment that is expected at a target location of a subject to which a compound according to Formula I (or IV, V, VI, or VII) is administered. In some embodiments, R³ or R⁴ will be released by esterased or acid base catalyzed reactions in cellular/tumor milieu when embodiments of compound according to Formula I (or IV, V, VI, or VII) are administered to a subjects having cancer. Cancer cells are often characterized with up-regulation of cellular esterases and their tumor microenvironment becomes acidic. Accordingly, esterased or acid base catalyzed release of, for example, a cyclooxygenase can be selectively released in the microenvironment of tumor or inside the tumor cells. Therefore, premature release of, for example, the cyclooxygenase can be minimal

It will be understood that the specific compounds and reaction schemes described above are presented for purposes of illustrating that a large variety of compounds according to, for example, Formula I, IV, V, VI or VII, can be made according to a variety of reaction schemes and are not presented for purposes of limitation.

As described in the EXAMPLES below, synthesis of Platin-M via conventional coupling reaction with TPP ligands was found to be problematic due to reduction of Pt(IV). However, an alternative route in which the mitochondria targeting TPP moiety was introduced on dibenzocyclooctyne (DBCO) derivative to result DBCO-TPP, proved effective for coupling to the Pt(IV) prodrug. A strain-promoted alkyne-azide cycloaddition (SPAAC) reaction between a azide-Pt(IV) precursor Platin-Az and DBCO-TPP resulted in Platin-M with high efficiency and purity. The presence of lipophilic DBCO-TPP moieties increased the lipophilic character of Platin-M and resulted in efficient loading inside the hydrophobic core of poly(lactide-co-glycolide)-b-polyethyleneglycol (PLGA-b-PEG) nanoparticles (NPs).

A general scheme showing R¹H, R²H and cisplatin resulting from reduction of Pt(IV) according to various embodiments presented herein to Pt (II) is provided below:

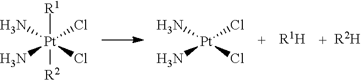

If R² is R⁴, and if R⁴ is a conjugated cyclooxygenase inhibitor, reduction of the Pt results in release of the cyclooxygenase inhibitor R²H. If R² contains a linker, L², as described above (e.g., x is 1), one or more R⁴ moiety can, in some instances, be released (e.g, via cleavage of a cleavable linker, hydrolysis, etc.) prior to reduction of the Pt and release of the remaining portion of R².

As discussed blow a Pt(IV) prodrug having one or more mitochondria targeting moieties may be, but need not be, included in a nanoparticle.

B. Nanoparticles

Nanoparticles, as described herein, include, in some embodiments, a hydrophobic core, a hydrophilic layer surrounding the core, a Pt(IV) prodrug comprising one or more mitochondria targeting moieties, one or more optional additional therapeutic agents, and one or more optional targeting moiety. In embodiments, the Pt(IV) prodrugs are contained or embedded within the core. The Pt(IV) prodrugs are preferably released from the core at a desired rate. In embodiments, the core is biodegradable and releases the Pt(IV) prodrugs as the core is degraded or eroded. The targeting moieties, if present, preferably extend outwardly from the core so that they are available for interaction with cellular components or so that they affect surface properties of the nanoparticle, which interactions or surface properties will favor preferential distribution to desired cells, such as cancer cells, or organelles such as mitochondria. The targeting moieties may be tethered to the core or components that interact with the core.

I. Core

The core of the nanoparticle may be formed from any suitable component or components. Preferably, the core is formed from hydrophobic components such as hydrophobic polymers or hydrophobic portions of polymers. The core may also or alternatively include block copolymers that have hydrophobic portions and hydrophilic portions that may self-assemble in an aqueous environment into particles having the hydrophobic core and a hydrophilic outer surface. In some embodiments, the core comprises one or more biodegradable polymer or a polymer having a biodegradable portion.

Any suitable synthetic or natural bioabsorbable polymers may be used. Such polymers are recognizable and identifiable by one or ordinary skill in the art. Non-limiting examples of synthetic, biodegradable polymers include: poly(amides) such as poly(amino acids) and poly(peptides); poly(esters) such as poly(lactic acid), poly(glycolic acid), poly(lactic-co-glycolic acid) (PLGA), and poly(caprolactone); poly(anhydrides); poly(orthoesters); poly(carbonates); and chemical derivatives thereof (substitutions, additions of chemical groups, for example, alkyl, alkylene, hydroxylations, oxidations, and other modifications routinely made by those skilled in the art), fibrin, fibrinogen, cellulose, starch, collagen, and hyaluronic acid, copolymers and mixtures thereof. The properties and release profiles of these and other suitable polymers are known or are readily identifiable.

In various embodiments, described herein the core comprises PLGA. PLGA is a well-known and well-studied hydrophobic biodegradable polymer used for the delivery and release of therapeutic agents at desired rates.

Preferably, the at least some of the polymers used to form the core are amphiphilic having hydrophobic portions and hydrophilic portions. The hydrophobic portions can form the core, while the hydrophilic regions may form a layer surrounding the core to help the nanoparticle evade recognition by the immune system and enhance circulation half-life. Examples of amphiphilic polymers include block copolymers having a hydrophobic block and a hydrophilic block. In some embodiments, the core is formed from hydrophobic portions of a block copolymer, a hydrophobic polymer, or combinations thereof.

The ratio of hydrophobic polymer to amphiphilic polymer may be varied to vary the size of the nanoparticle. Often, a greater ratio of hydrophobic polymer to amphiphilic polymer results in a nanoparticle having a larger diameter. Any suitable ratio of hydrophobic polymer to amphiphilic polymer may be used. In some embodiments, the nanoparticle includes about a 50/50 ratio by weight of amphiphilic polymer to hydrophobic polymer or ratio that includes more amphiphilic polymer than hydrophilic polymer, such as about 20/80 ratio, about a 30/70 ratio, about a 40/60 ratio, about a 55/45 ratio, about a 60/40 ratio, about a 65/45 ratio, about a 70/30 ratio, about a 75/35 ratio, about a 80/20 ratio, about a 85/15 ratio, about a 90/10 ratio, about a 95/5 ratio, about a 99/1 ratio, or about 100% amphiphilic polymer.

In embodiments, the hydrophobic polymer comprises PLGA, such as PLGA-COOH or PLGA-OH. In embodiments, the amphiphilic polymer comprises PLGA and PEG, such as PLGA-PEG. The amphiphilic polymer may be a dendritic polymer having branched hydrophilic portions. Branched polymers may allow for attachment of more than moiety to terminal ends of the branched hydrophilic polymer tails, as the branched polymers have more than one terminal end.

The nanoparticles described herein may have any suitable size. In some embodiments, the nanoparticles have an average diameter of about 500 nm or less, such as about 250 nm or less or about 200 nm or less. Typically, the nanoparticles will have an average diameter of about 5 nm or more. In some embodiments, the nanoparticles have an average diameter of from about 10 nm to about 300 nm, such as from about 20 nm to about 100 nm, or from about 30 nm to about 70 nm.

II. Hydrophilic Layer Surrounding the Core

The nanoparticles described herein may optionally include a hydrophilic layer surrounding the hydrophobic core. The hydrophilic layer may assist the nanoparticle in evading recognition by the immune system and may enhance circulation half-life of the nanoparticle.

As indicated above, the hydrophilic layer may be formed, in whole or in part, by a hydrophilic portion of an amphiphilic polymer, such as a block co-polymer having a hydrophobic block and a hydrophilic block.

Any suitable hydrophilic polymer or hydrophilic portion of an amphiphilic polymer may form the hydrophilic layer or portion thereof The hydrophilic polymer or hydrophilic portion of a polymer may be a linear or branched or dendritic polymer. Examples of suitable hydrophilic polymers include polysaccharides, dextran, chitosan, hyaluronic acid, polyethylene glycol, polymethylene oxide, and the like.

In some embodiments, a hydrophilic portion of a block copolymer comprises polyethylene glycol (PEG). In embodiments, a block copolymer comprises a hydrophobic portion comprising PLGA and a hydrophilic portion comprising PEG.

A hydrophilic polymer or hydrophilic portion of a polymer may contain moieties that are charged under physiological conditions, which may be approximated by a buffered saline solution, such as a phosphate or citrate buffered saline solution, at a pH of about 7.4, or the like. In various embodiments, a hydrophilic polymer or portion of a polymer includes a hydroxyl group that can result in an oxygen anion when placed in a physiological aqueous environment. For example, the polymer may include PEG-OH where the OH serves as the charged moiety under physiological conditions.

Moieties that are charged under physiological conditions may contribute to the charge density or zeta potential of the nanoparticle. Zeta potential is a term for electro kinetic potential in colloidal systems. While zeta potential is not directly measurable, it can be experimentally determined using electrophoretic mobility, dynamic electrophoretic mobility, or the like.

A nanoparticle as described herein may have any suitable zeta potential. In various embodiments, the nanoparticles described herein have a positive zeta potential. For example, the nanoparticles may have a zeta potential of about 5 mV or more. In some embodiments, nanoparticles described herein have a zeta potential of about 30 mV; e.g., from about 20 mV to about 40 mV.

III. Therapeutic Agents

A nanoparticle, as described herein, may include any one or more therapeutic agents in addition to a mitochondria-targeted Pt(IV) prodrug. The one or more therapeutic agents may be embedded in, or contained within, the core of the nanoparticle. Preferably, the one or more therapeutic agents are released from the core at a desired rate. If the core is formed from a polymer (such as PLGA) or combination of polymers having known release rates, the release rate can be readily controlled.

In embodiments, a therapeutic agent or precursor thereof is conjugated to a polymer, or other component of a nanoparticle, in a manner described above with regard to targeting moieties. The therapeutic agent may be conjugated via a cleavable linker.

The therapeutic agents may be present in the nanoparticle at any suitable concentration. For example, a therapeutic agent may be present in the nanoparticle at a concentration from about 0.01% to about 37% by weight of the nanoparticle.

In various embodiments, a nanoparticle includes one or more chemotherapeutic agent. As used herein, a “chemotherapeutic agent” is an agent for treatment of cancer, such as a cytotoxic agent or an anti-neoplastic agent. Any suitable chemotherapeutic agent may be included in a nanoparticle described herein. Examples of chemotherapeutic agents include (i) alkylating agents such as cyclophosphamide, mechlorethamine, chlorambucil, melphalan, and the like; (ii) anthracyclines such as daunorubicin, doxorubicin, epirubicin, idarubicin, mitoxantrone, valrubicin, and the like; (iii) cytoskeletal disruptors such as paclitaxel, docetaxel, and the like; (iv) epothilones such as epothilone and the like; (v) histone deactylase inhibitors such as vorinostat, romidepsin, and the like; (vi) inhibitors of topoisomerase I such as irinotecan, topotecan, and the like; (vii) inhibitors or topoisomerase II such as etoposide, teniposide, tafluposide, and the like; (viii) kinase inhibitors such as bortezomib, erlontib, gefitinib, imatinib, vermurafenib, vismodegib, vismodegib, and the like; (ix) monoclonal antibodies such as bevacizumab, cetuximab, ipilimuman, ofatumumab, ocrelizumab, panitumab, rituximab, and the like; (x) nucleotide analogs and precursor analogs such as azacitidine, azathioprine, capecitabine, cytarabine, doxifluridine, fluorouracil, gemcitabine, hydroxyurea, mercaptopurine, methotrexate, tioguanine, and the like; (xi) peptide antibiotics such as bleomycin, actinomycin, and the like; (xii) platinum-based agents such as carboplatin, cisplatin, oxaliplatin, and the like; (xiii) retinoids such as tretinoin, alitretinoin, bexarotene, and the like; (xiv) vinca alkaloids and derivatives such as vinblastine, vincristine, cindesine, vinorelbine, and the like; (xv) and the like. In some embodiments, at least one of the one or more chemotherapeutics are selected from the group consisting of docetaxel, mitoxantrone, paclitaxel, satraplatin, and cisplatin.

IV. Targeting Moieties

a. Cancer Targeting Moieties

Nanoparticles described herein may optionally include one or more moieties that target the nanoparticles to cancer cells. As used herein, “targeting” a nanoparticle to a cancer cell means that the nanoparticle accumulates in/on/near the targeted cancer relative to other cells at a greater concentration than a substantially similar non-targeted nanoparticle. A substantially similar non-targeted nanoparticle includes the same components in substantially the same relative concentration (e.g., within about 5%) as the targeted nanoparticle, but lacks a targeting moiety.

The cancer targeting moieties may be tethered to the core in any suitable manner, such as binding to a molecule that forms part of the core or to a molecule that is bound to the core. In some embodiments, a targeting moiety is bound to a hydrophilic polymer that is bound to a hydrophobic polymer that forms part of the core. In various embodiments, a targeting moiety is bound to a hydrophilic portion of a block copolymer having a hydrophobic block that forms part of the core.

The targeting moieties may be bound to any suitable portion of a polymer. In some embodiments, the targeting moieties are attached to a terminal end of a polymer. In various embodiments, the targeting moieties are bound to the backbone of the polymer, or a molecule attached to the backbone, at a location other than a terminal end of the polymer. More than one targeting moiety may be bound to a given polymer. In embodiments, the polymer is a dendritic polymer having multiple terminal ends and the targeting moieties may be bound to more than one of terminal ends.

The polymers, or portions thereof, to which the targeting moieties are bound may contain, or be modified to contain, appropriate functional groups, such as —OH, —COOH, —NH₂, —SH, —N₃, —Br, —Cl, —I, —CH═CH₂, C≡CH, —CHO or the like, for reaction with and binding to the targeting moieties that have, or are modified to have, suitable functional groups.

Targeting moieties may be present in the nanoparticles at any suitable concentration. It will be understood that the concentration may readily be varied based on initial in vitro analysis to optimize prior to in vivo study or use. In some embodiments, the targeting moieties will have surface coverage of from about 5% to about 100%.

Preferably, a targeting moiety is attached to a hydrophilic polymer or hydrophilic portion of a polymer so that the targeting moiety will extend from the core of the nanoparticle to facilitate the effect of the targeting moiety. In various embodiments, a targeting moiety is attached to PEG.

Any suitable cancer targeting moiety may be attached to a nanoparticle described herein. Examples of cancer targeting moieties include moieties that bind cell surface antigens or markers that are selective to cancer cells or over-expressed, up-regulated or otherwise present in amounts not found in non-cancer cells.

b. Mitochondria Targeting Moieties

In embodiments, a nanoparticle includes a mitochondria targeting moiety. Any suitable moiety for monitoring apoptosis may be incorporated into a nanoparticle. Examples of mitochondria targeting moieties that may be employed are described in, for example, WO 2013/033513 A1, entitled APOPTOSIS-TARGETING NANOPARTICLES and published on Mar. 7, 2013. In embodiments, the mitochondria targeting moiety is a moiety that facilitates accumulation of the nanoparticle in the mitochondrial matrix.

Any suitable moiety for facilitating accumulation of the nanoparticle within the mitochondrial matrix may be employed. Due to the substantial negative electrochemical potential maintained across the inner mitochondrial membrane, delocalized lipophilic cations are effective at crossing the hydrophobic membranes and accumulating in the mitochondrial matrix. Triphenyl phosophonium (TPP) containing compounds can accumulate greater than 10-10,000 times within the mitochondrial matrix. Any suitable TPP-containing compound may be used as a mitochondrial matrix targeting moiety. Representative examples of TPP-based moieties may have structures indicated below in Formula XII, Formula XIII or Formula XIV:

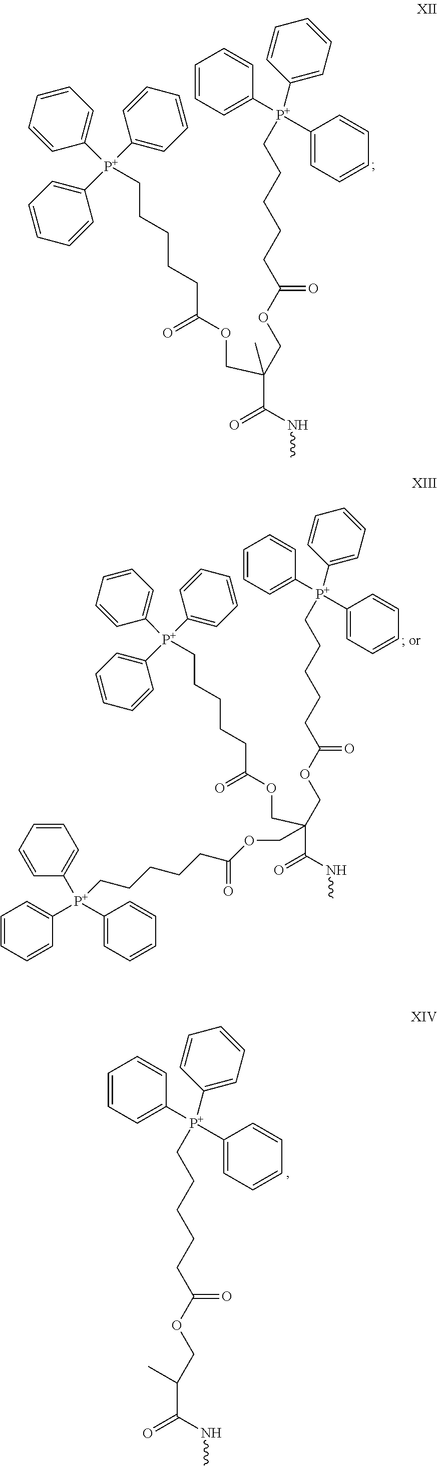

where the amine (as depicted) may be conjugated to a polymer, lipid, or the like for incorporation into the nanoparticle.

In embodiments, the delocalized lipophilic cation for targeting the mitochondrial matrix is a rhodamine cation, such as Rhodamine 123 having Formula XV as depicted below:

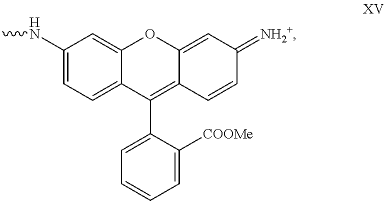

where the secondary amine (as depicted) may be conjugated to a polymer, lipid, or the like for incorporation into the nanoparticle.

Of course, non-cationic compounds may serve to target and accumulate in the mitochondrial matrix. By way of example, Szeto-Shiller peptide may serve to target and accumulate a nanoparticle in the mitochondrial matrix. Any suitable Szetto-Shiller peptide may be employed as a mitochondrial matrix targeting moiety. Non-limiting examples of suitable Szeto-Shiller peptides include SS-02 and SS-31, having Formula XVI and Formula XVII, respectively, as depicted below:

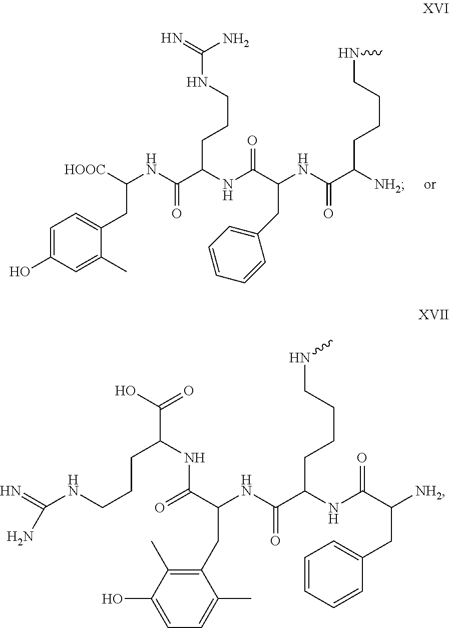

where the secondary amine (as depicted) may be conjugated to a polymer, lipid, or the like for incorporation into the nanoparticle.

For purposes of example, a reaction scheme for synthesis of distearoyl-snglycero-3-phosphoethanolamine (DSPE)-PEG-TPP is shown below in Scheme 4. It will be understood that other schemes may be employed to synthesize DSPE-PEG-TPP and that similar reaction schemes may be employed to tether other mitochondrial targeting moieties to DSPE-PEG or to tether moieties to other polymers, copolymers, or lipids for purposes of incorporating the targeting moiety into a nanoparticle.

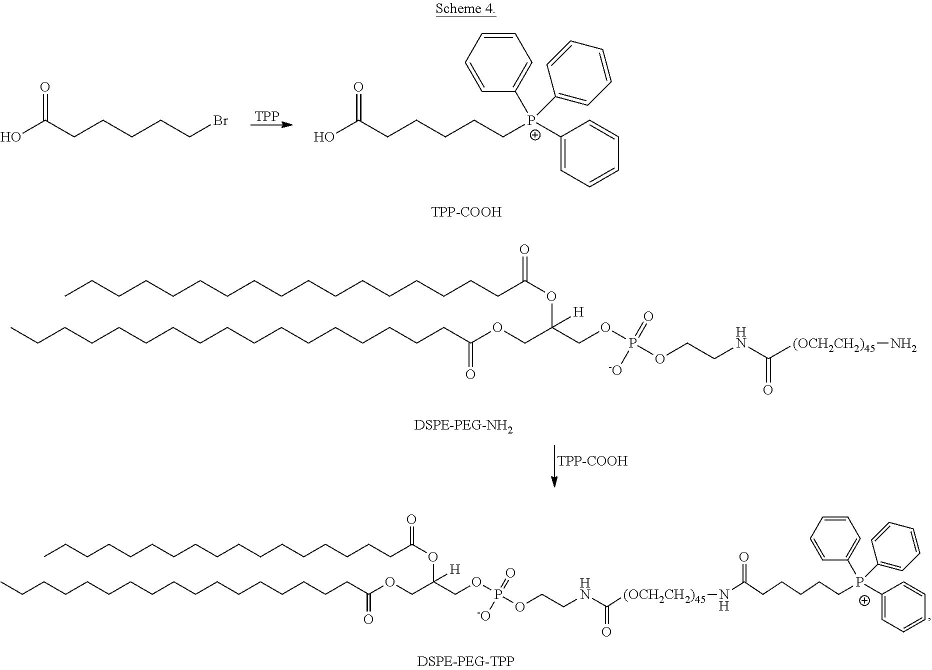

V. Synthesis of Nanoparticle

Nanoparticles, as described herein, may be synthesized or assembled via any suitable process. Preferably, the nanoparticles are assembled in a single step to minimize process variation. A single step process may include nanoprecipitation and self-assembly.

In general, the nanoparticles may be synthesized or assembled by dissolving or suspending hydrophobic components in an organic solvent, preferably a solvent that is miscible in an aqueous solvent used for precipitation. In embodiments, acetonitrile is used as the organic solvent, but any suitable solvent such as dimethlyformamide (DMF), dimethyl sulfoxide (DMSO), acetone, or the like may be used. Hydrophilic components are dissolved in a suitable aqueous solvent, such as water, 4 wt-% ethanol, or the like. The organic phase solution may be added drop wise to the aqueous phase solution to nanoprecipitate the hydrophobic components and allow self-assembly of the nanoparticle in the aqueous solvent.

A process for determining appropriate conditions for forming the nanoparticles may be as follows. Briefly, functionalized polymers and other components, if included or as appropriate, may be co-dissolved in organic solvent mixtures. This solution may be added drop wise into hot (e.g, 65° C.) aqueous solvent (e.g, water, 4 wt-% ethanol, etc.), whereupon the solvents will evaporate, producing nanoparticles with a hydrophobic core surrounded by a hydrophilic polymer component, such as PEG. Once a set of conditions where a desired level of targeting moiety surface loading (if present) has been achieved, therapeutic agents may be included in the nanoprecipitation and self-assembly of the nanoparticles.

If results are not desirably reproducible by manual mixing, microfluidic channels may be used.

Nanoparticles may be characterized for their size, charge, stability, drug loading, drug release kinetics, surface morphology, and stability using well-known or published methods.

Nanoparticle properties may be controlled by (a) controlling the composition of the polymer solution, and (b) controlling mixing conditions such as mixing time, temperature, and ratio of water to organic solvent. The likelihood of variation in nanoparticle properties increases with the number of processing steps required for synthesis.

The size of the nanoparticle produced can be varied by altering the ratio of hydrophobic core components to amphiphilic shell components. Nanoparticle size can also be controlled by changing the polymer length, by changing the mixing time, and by adjusting the ratio of organic to the phase. Prior experience with nanoparticles from PLGA-b-PEG of different lengths suggests that nanoparticle size will increase from a minimum of about 20 nm for short polymers (e.g. PLGA₃₀₀₀-PEG₇₅₀) to a maximum of about 150 nm for long polymers (e.g. PLGA_{100,000}-PEG_{10,000}). Thus, molecular weight of the polymer will serve to adjust the size.

Nanoparticle surface charge can be controlled by mixing polymers with appropriately charged end groups. Additionally, the composition and surface chemistry can be controlled by mixing polymers with different hydrophilic polymer lengths, branched hydrophilic polymers, or by adding hydrophobic polymers.

Once formed, the nanoparticles may be collected and washed via centrifugation, centrifugal ultrafiltration, or the like. If aggregation occurs, nanoparticles can be purified by dialysis, can be purified by longer centrifugation at slower speeds, can be purified with the use surfactant, or the like.

Once collected, any remaining solvent may be removed and the particles may be dried, which should aid in minimizing any premature breakdown or release of components. The nanoparticles may be freeze dried with the use of bulking agents such as mannitol, or otherwise prepared for storage prior to use.

It will be understood that therapeutic agents may be placed in the organic phase or aqueous phase according to their solubility.

Nanoparticles described herein may include any other suitable components, such as phospholipids or cholesterol components, generally know or understood in the art as being suitable for inclusion in nanoparticles. PCT patent application, PCT/US2012/053307, describes a number of additional components that may be included in nanoparticles.

Nanoparticles disclosed in PCT/US2012/053307 include targeting moieties that target the nanoparticles to apoptotic cells, such as moieties that target phosphatidylserine (PS). The targeting moieties are conjugated to a component of the nanoparticle. Such moieties include various polypeptides or zinc 2,2′-dipicolylamine (Zn²⁺-DPA) coordination complexes. In embodiments, the nanoparticles described herein are free or substantially fee of apoptotic cell targeting moieties. In embodiments, the nanoparticles described herein are free or substantially fee of apoptotic cell targeting moieties that are conjugated to a component of the nanoparticle. In embodiments, the nanoparticles described herein are free or substantially fee of PS targeting moieties. In embodiments, the nanoparticles described herein are free or substantially fee of PS targeting moieties that are conjugated to a component of the nanoparticle. In embodiments, the nanoparticles described herein are free or substantially fee of PS-polypeptide targeting moieties or Zn²⁺-DPA moieties. In embodiments, the nanoparticles described herein are free or substantially fee of PS-polypeptide targeting moieties or Zn²⁺-DPA moieties that are conjugated to a component of the nanoparticle.

Nanoparticles disclosed in PCT/US2012/053307 include macrophage targeting moieties, such as simple sugars, conjugated to components of the nanoparticles. In embodiments, the nanoparticles described herein are free or substantially free of macrophage targeting moieties. In embodiments, the nanoparticles described herein are free or substantially free of macrophage targeting moieties that are conjugated to the nanoparticle or a component thereof. In embodiments, the nanoparticles described herein are free or substantially free of simple sugar moieties. In embodiments, the nanoparticles described herein are free or substantially free of simple sugar moieties that are conjugated to the nanoparticle or a component thereof

C. Use of Prodrug or Nanoparticle

A Pt(IV) prodrug or a nanoparticle including a Pt(IV) prodrug described herein can be used for any suitable purpose. In some embodiments, a Pt(IV) prodrug or a nanoparticle including a Pt(IV) prodrug is used to treat a subject having, suffering from, or at risk of a cancer, a proliferative disease, a mitochondria disease, a CNS disease or an inflammatory disease.

“Treating a subject having a cancer” includes achieving, partially or substantially, one or more of the following: arresting the growth or spread of a cancer, reducing the extent of a cancer (e.g., reducing size of a tumor or reducing the number of affected sites), inhibiting the growth rate of a cancer, and ameliorating or improving a clinical symptom or indicator associated with a cancer (such as tissue or serum components).

Effective amounts of a Pt(IV) prodrug or a nanoparticle including a Pt(IV) prodrug can be administered to a subject to treat an inflammatory disease. Inflammatory diseases that can be treated include disorders characterized by one or both of localized and systemic inflammatory reactions, including, diseases involving the gastrointestinal tract and associated tissues (such as appendicitis, peptic, gastric and duodenal ulcers, peritonitis, pancreatitis, ulcerative, pseudomembranous, acute and ischemic colitis, inflammatory bowel disease, diverticulitis, epiglottitis, achalasia, cholangitis, coeliac disease, cholecystitis, hepatitis, Crohn's disease, enteritis, and Whipple's disease); systemic or local inflammatory diseases and conditions (such as asthma, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, and sarcoidosis); diseases involving the urogential system and associated tissues (such as septic abortion, epididymitis, vaginitis, prostatitis and urethritis); diseases involving the respiratory system and associated tissues (such as bronchitis, emphysema, rhinitis, cystic fibrosis, adult respiratory distress syndrome, pneumonitis, pneumoultramicroscopicsilicovolcanoconiosis, alvealitis, bronchiolitis, pharyngitis, pleurisy, and sinusitis); diseases arising from infection by various viruses (such as influenza, respiratory syncytial virus, HIV, hepatitis B virus, hepatitis C virus and herpes), bacteria (such as disseminated bacteremia, Dengue fever), fungi (such as candidiasis) and protozoal and multicellular parasites (such as malaria, filariasis, amebiasis, and hydatid cysts); dermatological diseases and conditions of the skin (such as burns, dermatitis, dermatomyositis, sunburn, urticaria warts, and wheals); diseases involving the cardiovascular system and associated tissues (such as vasulitis, angiitis, endocarditis, arteritis, atherosclerosis, thrombophlebitis, pericarditis, myocarditis, myocardial ischemia, congestive heart failure, periarteritis nodosa, and rheumatic fever); diseases involving the central or peripheral nervous system and associated tissues (such as Alzheimer's disease, meningitis, encephalitis, multiple sclerosis, cerebral infarction, cerebral embolism, Guillame-Barre syndrome, neuritis, neuralgia, spinal cord injury, paralysis, and uveitis); diseases of the bones, joints, muscles and connective tissues (such as the various arthritides and arthralgias, osteomyelitis, fasciitis, Paget's disease, gout, periodontal disease, rheumatoid arthritis, and synovitis); other autoimmune and inflammatory disorders (such as myasthenia gravis, thryoiditis, systemic lupus erythematosus, Goodpasture's syndrome, Behcets's syndrome, allograft rejection, graft-versus-host disease, Type I diabetes, ankylosing spondylitis, Berger's disease, diabetes including Type I diabetes, ankylosing spondylitis, Berger's disease, and Retier's syndrome); nosicomal infection; and various cancers, tumors and proliferative disorders (such as Hodgkins disease).

Any suitable type of cancer can be treated by administering an effective amount of a Pt(IV) prodrug or a nanoparticle including a Pt(IV) prodrug to a subject in need thereof. Cancers that can be treated or prevented by administering an effective amount of Pt(IV) prodrug or a nanoparticle including a Pt(IV) prodrug to a subject in need thereof include, but are not limited to, human sarcomas and carcinomas, e.g., fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, colorectal cancer, anal carcinoma, esophageal cancer, gastric cancer, hepatocellular cancer, bladder cancer, endometrial cancer, pancreatic cancer, breast cancer, ovarian cancer, prostate cancer, stomach cancer, atrial myxomas, squamous cell carcinoma, basal cell carcinoma, adenocarcinoma, sweat gland carcinoma, sebaceous gland carcinoma, thyroid and parathyroid neoplasms, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, testicular tumor, lung carcinoma, small cell lung carcinoma, non-small-cell lung cancer, bladder carcinoma, epithelial carcinoma, glioma, pituitary neoplasms, astrocytoma, medulloblastoma, craniopharyngioma, ependymoma, pinealoma, hemangioblastoma, acoustic neuroma, schwannomas, oligodendroglioma, meningioma, spinal cord tumors, melanoma, neuroblastoma, pheochromocytoma, Types 1-3 endocrine neoplasia, retinoblastoma; leukemias, e.g., acute lymphocytic leukemia and acute myelocytic leukemia (myeloblastic, promyelocytic, myelomonocytic, monocytic and erythroleukemia); chronic leukemia (chronic myelocytic (granulocytic) leukemia and chronic lymphocytic leukemia); and polycythemia vera, lymphoma (Hodgkin's disease and non-Hodgkin's disease), multiple myeloma, Waldenstrobm's macroglobulinemia, and heavy chain disease. It is believed that a Pt(IV) prodrug or a nanoparticle including a Pt(IV) prodrug may be particularly effective in treating a subject having prostate cancer. In some embodiments, an effective amount of a Pt(IV) prodrug or a nanoparticle including a Pt(IV) prodrug is administered to a subject to treat Castration-Resistant Prostate Cancer (CRPC).

Effective amounts of a Pt(IV) prodrug or a nanoparticle including a Pt(IV) prodrug can be administered to a subject to treat a non-cancer proliferative disorder. Non-cancerous proliferative disorders include smooth muscle cell proliferation, systemic sclerosis, cirrhosis of the liver, adult respiratory distress syndrome, idiopathic cardiomyopathy, lupus erythematosus, retinopathy, e.g., diabetic retinopathy or other retinopathies, cardiac hyperplasia, reproductive system associated disorders such as benign prostatic hyperplasia and ovarian cysts, pulmonary fibrosis, endometriosis, fibromatosis, harmatomas, lymphangiomatosis, sarcoidosis, desmoid tumors and the like.

An “effective amount” is the quantity of compound or nanoparticle in which a beneficial clinical outcome is achieved when the compound or nanoparticle is administered to a subject. For example, when a Pt(IV) prodrug or a nanoparticle including a Pt(IV) prodrug is administered to a subject with a cancer, a “beneficial clinical outcome” includes a reduction in tumor mass, a reduction in metastasis, a reduction in the severity of the symptoms associated with the cancer or an increase in the longevity of the subject compared with the absence of the treatment.

The precise amount of compound or nanoparticle administered to a subject will depend on the type and severity of the disease or condition and on the characteristics of the subject, such as general health, age, sex, body weight and tolerance to drugs. It may also depend on the degree, severity and type of cancer. The skilled artisan will be able to determine appropriate dosages depending on these and other factors. Effective amounts of the disclosed compounds may range between about 1 mg/mm² per day and about 10 grams/mm² per day. If co-administered with another anti-cancer agent for the treatment of cancer, an “effective amount” of the second anti-cancer agent will depend on the type of drug used. Suitable dosages are known for approved anti-cancer agents and can be adjusted by the skilled artisan according to the condition of the subject, the type of cancer being treated and the Pt(IV) prodrug or a nanoparticle including a Pt(IV) prodrug being used.

In various embodiments, a Pt(IV) prodrug, a tautomer, pharmaceutically acceptable salt, solvate, or clathrate thereof or a nanoparticle including a Pt(IV) prodrug, or a tautomer, pharmaceutically acceptable salt, solvate, or clathrate thereof, can be included in a pharmaceutical composition. The pharmaceutical composition can include the compound and a pharmaceutically acceptable carrier or diluent.

Suitable pharmaceutically acceptable carriers may contain inert ingredients that preferably do not inhibit the biological activity of a Pt(IV) prodrug. Pharmaceutically acceptable carriers are preferably biocompatible, i.e., non-toxic, non-inflammatory, non-immunogenic and devoid of other undesired reactions upon the administration to a subject. Standard pharmaceutical formulation techniques can be employed, such as those described in Remington's Pharmaceutical Sciences, Mack Publishing Company, Easton, Pa. Formulation of the compound to be administered will vary according to the route of administration selected (e.g., solution, emulsion, capsule). Suitable pharmaceutical carriers for parenteral administration include, for example, sterile water, physiological saline, bacteriostatic saline (saline containing about 0.9% mg/ml benzyl alcohol), phosphate-buffered saline, Hank's solution, Ringer's-lactate and the like. Methods for encapsulating compositions (such as in a coating of hard gelatin or cyclodextrins) are known in the art (Baker, et al., “Controlled Release of Biological Active Agents”, John Wiley and Sons, 1986).

A Pt(IV) prodrug or a nanoparticle including a Pt(IV) prodrug can be administered by any suitable route, including, for example, orally in capsules, suspensions or tablets or by parenteral administration. Parenteral administration can include, for example, systemic administration, such as by intramuscular, intravenous, subcutaneous, or intraperitoneal injection. The compounds of the invention can also be administered orally (e.g., dietary), topically, by inhalation (e.g., intrabronchial, intranasal, oral inhalation or intranasal drops), or rectally, depending on the type of cancer to be treated.

Many new drugs are now available to be used by oncologists in treating patients with cancer. Often, tumors are more responsive to treatment when anti-cancer drugs are administered in combination to the patient than when the same drugs are administered individually and sequentially. One advantage of this approach is that the anti-cancer agents often act synergistically because the tumors cells are attacked simultaneously with agents having multiple modes of action. Thus, it is often possible to achieve more rapid reductions in tumor size by administering these drugs in combination. Another advantage of combination chemotherapy is that tumors are more likely to be eradicated completely and are less likely to develop resistance to the anti-cancer drugs being used to treat the patient.

Any mitochondrial disease can be treated with a compound or nanoparticle disclosed herein. Examples of mitochondria diseases that can be treated include mitochondrial myopathy, diabetes mellitus and deafness, Leber's hereditary optic neuropathy, Wolff-Parkinson-White syndrome, multiple sclerosis, Leigh syndrome, Neuropathy, ataxia, retinitis pigmentosa and ptosis (NARP), myoneurogenic gastrointestinal encephalopathy, Myoclonic Epilepsy with Ragged Red Fibers (MERRF), and the like.

D. Definitions

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like.

As used herein, “disease” means a condition of a living being or one or more of its parts that impairs normal functioning. As used herein, the term disease encompasses terms such disease, disorder, condition, dysfunction and the like.

As used herein, “treat” or the like means to cure, prevent, or ameliorate one or more symptom of a disease.

As used herein, a compound that is “hydrophobic” is a compound that is insoluble in water or has solubility in water below 1 milligram/liter.

As used herein a compound that is “hydrophilic” is a compound that is water soluble or has solubility in water above 1 milligram/liter.

As used herein, “bind,” “bound,” or the like means that chemical entities are joined by any suitable type of bond, such as a covalent bond, an ionic bond, a hydrogen bond, van der walls forces, or the like. “Bind,” “bound,” and the like are used interchangeable herein with “attach,” “attached,” and the like.

As used herein, a molecule or moiety “attached” to a core of a nanoparticle may be embedded in the core, contained within the core, attached to a molecule that forms at least a portion of the core, attached to a molecule attached to the core, or directly attached to the core.

VIII. Incorporation by Reference

Each of the patents, published patent applications, provisional patent applications and non-patent literature cited herein is hereby incorporated herein by reference in its respective entirety to the extent that it does not conflict with the present disclosure.

In the following, non-limiting examples are presented, which describe various embodiments of representative nanoparticles, methods for producing the nanoparticles, and methods for using the nanoparticles.

### EXAMPLES

Construction of Mitochondria-Targeted Cisplatin Prodrug. A mitochondria-targeted cisplatin analogue can be very beneficial for overcoming resistance and potentially for understanding cisplatin mediated mitochondrial toxicity. A mitochondria-targeted Pt(IV)-prodrug of cisplatin, Platin-M, was designed by introducing two mitochondria targeting delocalized lipophilic TPP cations in the axial positions (FIG. 1).

Pt(IV) prodrugs are advantageous over the Pt(II) counterparts because of their greater stability and local activation which allow a greater proportion of the active drug at the target site(s). Inertness towards substitutions play significant roles for Pt(IV) complexes to demonstrate fewer side effects and reduced drug loss owing to premature deactivation.

Mitochondrial function including respiration is greatly reduced in cancer cells and tumor microenvironments differ greatly from that of normal tissues. Mitochondrial membrane potential (ΔΨₘ) in most cancer cells is greater compared that of normal cells. Therefore, TPP cation containing Platin-M will take advantage of the substantial negative ΔΨₘ across the inner mitochondrial membrane (IMM) to efficiently accumulate inside the matrix once the prodrug is released from the NPs (FIG. 1).

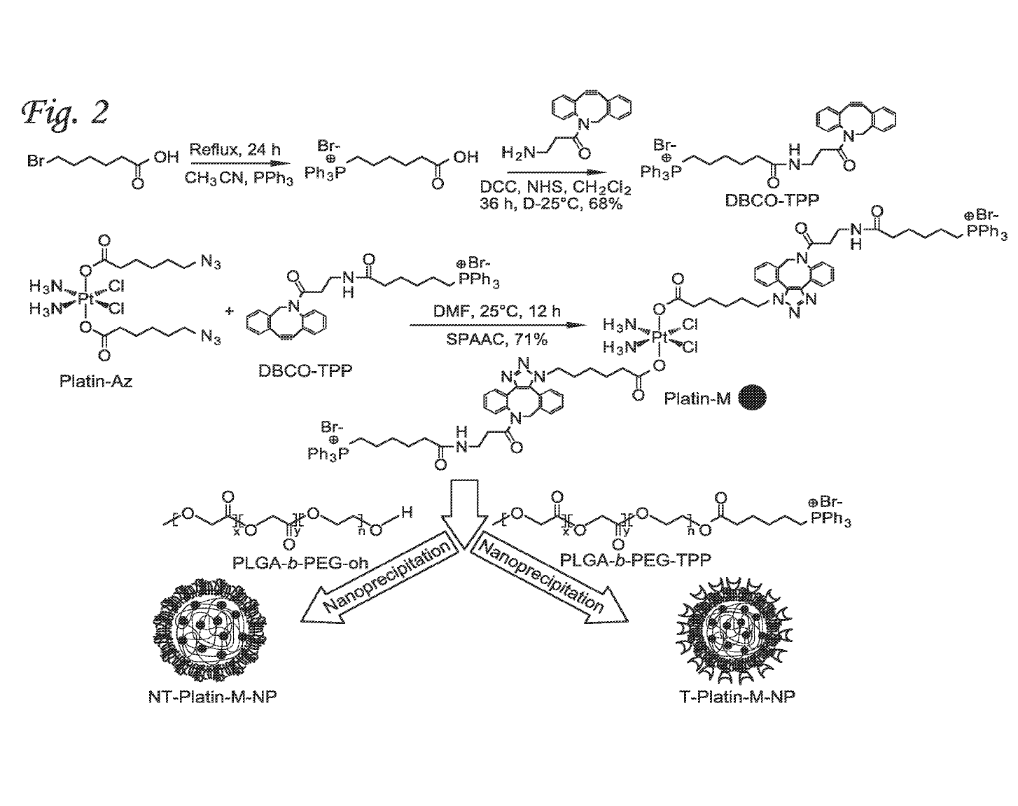

Synthetic strategy of Platin-M is shown in FIG. 2. Conventional coupling reaction with TPP ligands was found to be problematic due to reduction of Pt(IV). We recently developed a cycloaddition approach to introduce numerous functionalities on to Pt(IV) with high efficiency by keeping in mind that copper(I) based click chemistry can also cause reduction of Pt(IV). A TPP moiety was introduced on dibenzocyclooctyne (DBCO) derivative to result DBCO-TPP (FIG. 2, FIGS. S1-S4). A strain-promoted alkyne-azide cycloaddition (SPAAC) reaction between an azide-Pt(IV) precursor Platin-Az (Pathak, R. K., et al. Chem Eur J DOI: 10.1002/chem.201402573) recently developed by us and DBCO-TPP resulted Platin-M with high efficiency (FIG. 2). The prodrug Platin-M was characterized using microanalysis and spectroscopic techniques (FIGS. S5-S10). Feasible cellular reduction of Pt(IV) prodrug is required to release active cisplatin. Electrochemical studies performed at two different biologically relevant pH values of 7.4 and 6.0 demonstrated that Platin-M will release active cisplatin in the cellular environment (data not shown).

Development of mitochondria-targeted NP for Platin-M. Small molecules, in particular Pt-based therapeutics show poor biodistribution (bioD) and pharmacokinetic (PK) properties, rapid clearance, and inactivation by biological nucleophiles before reaching the cellular targets. We anticipated that mitochondria-targeted Pt(IV) prodrug Platin-M will face similar challenges if administered in its pristine form and therefore reducing the desired mitochondria targeting. Self-assembled polymeric nanoparticles (NPs) composed of biodegradable poly(D,L-lactic-co-glycolic acid)-block (PLGA-b)-poly(ethylene glycol) (PEG) block copolymer hold promise as carriers of small molecules. However, the NP system that can deliver Platin-M successfully to the mitochondria of cells can be challenging.

We recently developed an engineered NP system from a triblock copolymer PLGA-b-PEG-TPP and identified an optimized formulation for mitochondria delivery of small molecules. We anticipated that further engineering of our previously reported NP might show better bioD, PK, and increased accumulation of Platin-M in the mitochondrial matrix where mtDNA are located. We constructed two triblock copolymers PLGA_{LMW}-b-PEG-TPP (data not shown) and PLGA_{HMW}-b-PEG-TPP (data not shown) based on a low molecular weight and a high molecular weight PLGA polymers, respectively with the aim of efficient mitochondrial distribution for controlled release of Platin-M (FIG. 2). We anticipated that engineering of NPs from polymers of different molecular weight would allow us to have a control over NP distribution in different mitochondrial compartments, outer mitochondrial membrane (OMM), IMM, the intermembrane space (IMS), and matrix of mitochondria and additionally control the release kinetics of Platin-M from these NPs.

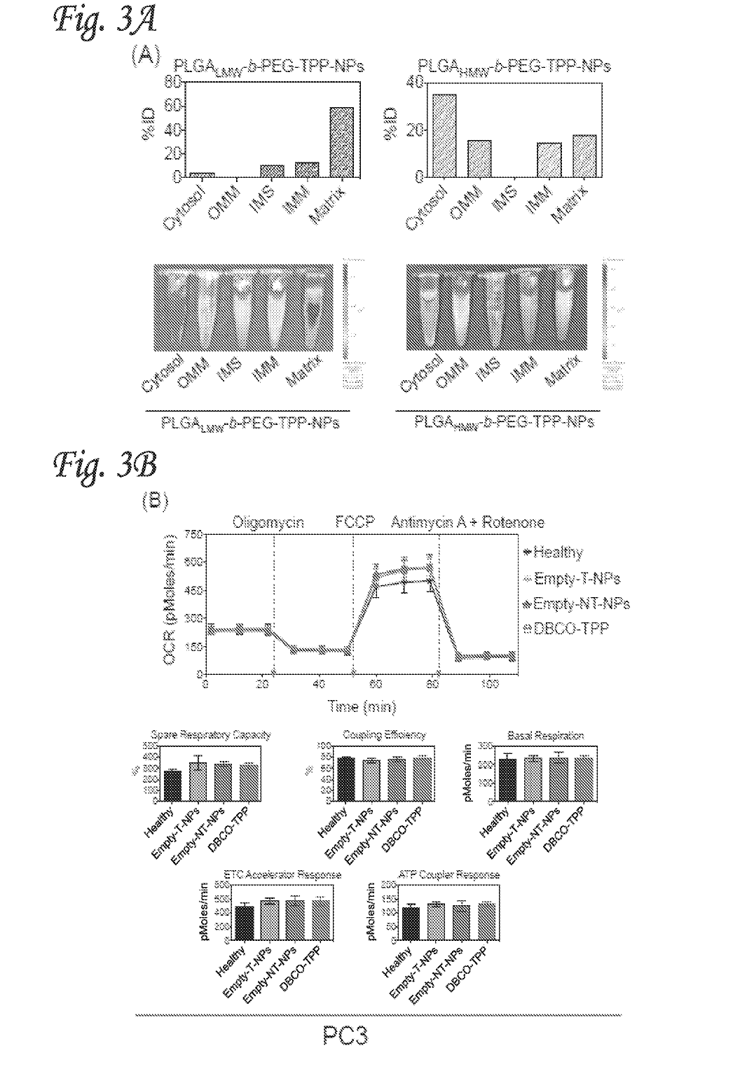

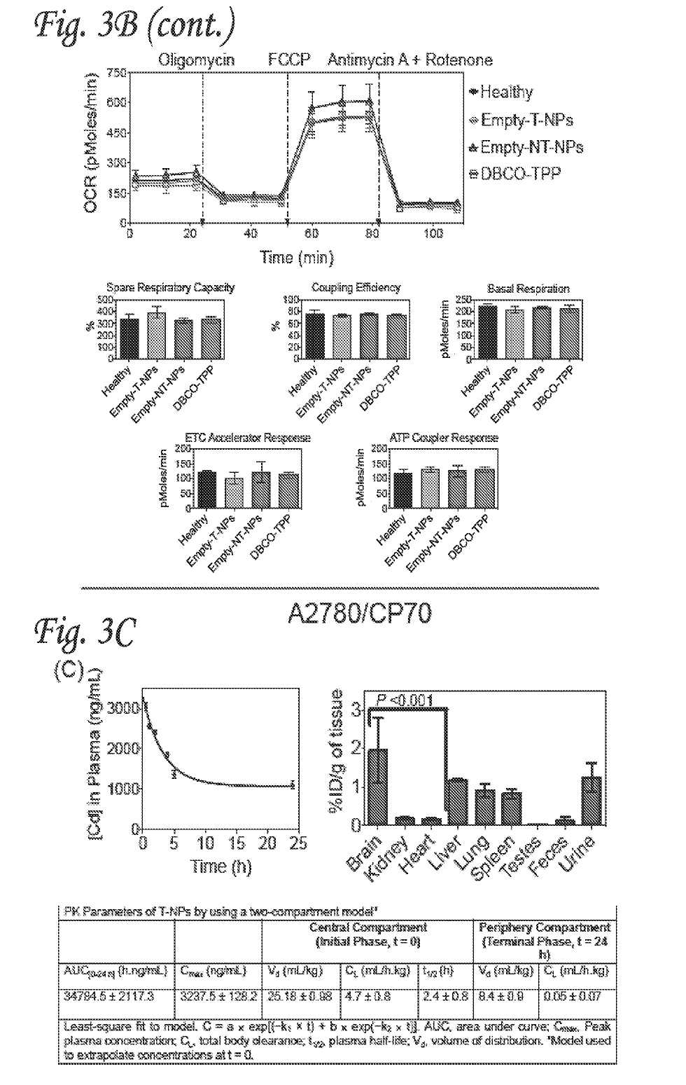

From our previous report, we know preferential accumulation of PLGA-b-PEG-TPP-based NPs in mitochondria by confocal microscopy and by inductively coupled plasma mass spectrometry (ICPMS) in whole mitochondrial fractions. To understand further the distribution properties of the NPs in different mitochondrial compartment, we fractionated mitochondria isolated from prostate cancer PC3 cells treated with NPs from PLGA_{HMW}-b-PEG-TPP and PLGA_{LMW}-b-PEG-TPP into OMM, IMM, IMS, and mitochondrial matrix fractions. We incorporated 10% of PLGA-b-PEG-quantum dot (QD) in both the NPs for their quantification in different cellular and intracellular compartments. Cd quantification by ICP-MS and imaging using a in vivo imaging system (IVIS) of cytosolic, IMM, OMM, IMS, and mitochondrial matrix indicated that the NPs from PLGA_{LMW}-b-PEG-TPP distribute most efficiently in the mitochondrial matrix, the NPs from PLGA_{HMW}-b-PEG-TPP distributed mainly in the OMM (FIG. 3A). We therefore, used NPs based on PLGA_{LMW}-b-PEG-TPP for efficient delivery of Platin-M inside the mitochondria for all further studies.

Mitochondrial Toxicity of T-NP. We next studied whether empty targeted-NPs (T-NPs) containing TPP molecules exhibit any deleterious effects after entering mitochondria. Many TPP-based small molecules were described to disrupt ΔΨₘ, uncouple OXPHOS, and inhibit mitochondrial respiration. Preclinical mitochondrial toxicology tests can have high positive predictive value. We examined Empty-T-NP, Empty-nontargeted-NPs (NT-NP), and DBCO-TPP induced changes in mitochondrial respiration of prostate cancer (PCa) PC3 cells and cisplatin resistant ovarian cancer A2780/CP70 cells as a measure of mitochondrial toxicity (FIG. 3B). The oxygen consumption rate (OCR) of cells is an important indicator of normal mitochondrial functions. Thus, OCR can be used as a parameter to study TPP-induced mitochondrial toxicity. Mitochondrial bioenergetic functions in PC3 and A2780/CP70 cells in the presence of Empty-T-NPs, Empty-NT-NPs, and DBCO-TPP were assessed using the XF24 extracellular flux analyzer.

Both cell lines were treated with Empty-T-NPs (0.5 mg/mL), Empty-NT-NPs (0.5 mg/mL), and DBCOTPP (10 μM), for 12 h followed by washout of the treatments and returned to fresh culture media. After 12 h, OCR was measured and the effects of metabolic modulators oligomycin, carbonyl cyanide 4-(trifluoromethoxy)phenylhydrazone (FCCP), antimycin A, and rotenone allowed determination of multiple parameters of mitochondrial function (FIG. 3B). Empty-T-NPs and DBCO-TPP did not show any changes in the basal OCR and the OCR linked to ATP production in the treated cells. Several parameters linked to mitochondrial respiration; spare respiratory capacity, coupling efficiency, basal respiration, ETC accelerator response, and ATP coupler response were calculated from the OCR (pMoles/min) vs. Time (min) traces in FIG. 3B. The ATP synthase inhibitor oligomycin was injected to evaluate mitochondrial coupling upon accumulation of T-NPs inside the mitochondria in these cells.

When proton flux through the ATP synthase is inhibited, phosphorylating respiration stops and residual oxygen consumption is primarily due to proton leak across the IMM. Oligomycin decreased OCR to the same level in healthy and Empty-T-NPs and DBCO-TPP treated cells (FIG. 3B) indicating that the mitochondria remain coupled. Next, we injected FCCP, a H+ ionophore and uncoupler of oxidative phosphorylation, to examine maximal respiratory capacity. FCCP dissipates the proton gradient across the IMM and uncouple electron transport from oxidative phosphorylation, thus, in the presence of FCCP, OCR increases to the maximum extent supported by the ETC and substrate supply. Stimulation of respiration by FCCP in healthy and Empty-T-NPs and DBCO-TPP to the same extent indicated that bioenergetic functions are well preserved in the treated cells. Complete inhibition of mitochondrial flux by addition of rotenone, a complex I inhibitor and antimycin A, a complex III inhibitor in healthy and Empty-T-NPs and DBCO-TPP treated cells indicated similar levels of mitochondrial and non-mitochondrial respiration. Collectively, these data suggested that several TPP containing T-NPs enter mitochondrial matrix very efficiently, however these NPs do not cause any mitochondrial inhibition or toxicity. This property makes the T-NPs suitable for delivery of therapeutics inside the mitochondria. The low toxicity behavior of DBCO-TPP indicated that it is suitable ligand for construction of Platin-M.

Keeping in mind that heart cells contain hyperpolarized mitochondria, we looked at the toxicity of mitochondria accumulating Empty-T-NPs in cardiomyocytes (data not shown). Cultured primary cardiomyocytes are a valuable tool for studying the metabolic capacity of the heart. A major limitation for isolated cardiomyocytes is that they are fragile and difficult to isolate. Therefore, we used a commercially available myogenic cell line derived from embryonic rat heart ventricle H9C2 as an in vitro model. Mitochondrial function assay using mitochondrial inhibitors as described before on the cardiomyocytes after treatment with 0.5 mg/mL Empty-T-NPs and Empty-NT-NPs for 12 h had no significant effects on basal OCR levels in these cells (data not shown). However, it should be noted the basal OCR levels in cardiomyocytes are low compared to other cells indicating significant mitochondria' hyperpolarization. None of the parameters such as basal respiration, coupling efficiency, spare respiratory capacity were affected by the presence of the T or NT-NPs. These results together indicated that the mitochondria targeted NPs do not have any deleterious effect on the heart cells.

Long Circulating T-NPs Distribute in the Brain. For potential in vivo translation of T-NPs in delivering Platin-M, bioD, excretion, and PK properties of T-NPs are the most critical bottlenecks. We injected T-QD-NPs into Sprague Dawley rats by a single dose intravenous injection to understand PK and bioD properties of the T-NPs. Blood samples at predetermined time points up to 24 h post injection, organs after 24 h, and cumulative urine, feces over 24 h were collected and analyzed for Cd by ICP-MS. Quantification of PK parameters by a two-compartment intravenous input model revealed a plasma elimination half life (t_{1/2}) from the central compartment of 2.4 h followed by a very high t₁₁₂ value in the periphery compartment of ˜214 h (FIG. 3C).

The total body clearance (CL) of T-NPs was ˜4.7 mL/h.kg in the central compartment and 0.05 mL/h.kg in the terminal phase (FIG. 3C). The high t_{1/2} and a small CL values indicated long circulating properties of T-NPs. The significantly higher area under curve (AUC) of 34784±2117 h.ng/mL further supported the long circulation property of these NPs. A peak plasma concentration (Cmax) of 3237±128 ng/mL indicated that these mitochondria 10 targeted NPs are distributed into bloodstream very effectively (FIG. 3C). A large volume of distribution (Vd) in the central compartment indicated that initially the T-NPs distribute extensively into body tissues. However a reduced Vd in the terminal compartment supported that due to their unique composition with sterically hindered surface covered with −TPP moieties, these NPs exhibited decreased protein binding and thus the T-NPs will be excellent candidate for mitochondrial delivery of Platin-M.

The variation of T-NP levels in the major tissues, including spleen, liver, lungs, brain, heart, kidney, and testes at 24 h post-dose indicated that the maximum NP accumulation was in the brain (FIG. 3C). The dichotomy between the brain capillary endothelium forming the blood-brain-barrier (BBB) and endothelia in peripheral prevent the passage of larger NPs with hydrophilic anionic surface. Pass from blood to brain of circulating NPs may only happen by transcellular mechanisms, which require a highly lipophilic NP system suitable size and charge. Brain endothelial cell surface and basement membrane components bearing highly anionic charges from sulphated proteoglycans are different from non-brain endothelium and would allow the adsorptive-mediated transcytosis of cationic NPs. Thus the small size and highly lipophilic surface provided by the T-NPs helped their distribution in the brain.

Furthermore, the high density of mitochondria in cerebral endothelial cells than in peripheral endothelia provided opportunity for these T-NPs to be accumulated in the brain efficiently. The distinctive properties of brain endothelium and highly lipophilic mitochondria targeting properties of T-NPs provided selective targeting of these NPs to the brain. The concentration of the T-NPs in spite of positively charged surface showed a very high brain-to-spleen ratio of ˜2.4 (FIG. 3C). The T-NPs also showed a high brain-to-kidney ratio of ˜10 and a moderate brain-to-liver ratio of ˜1.6 (FIG. 3C). In many instances, positively charged NPs accumulate in the liver and the spleen by phagocytic cells present in the mononuclear phagocyte system (MPS) located primarily in these organs. A high brain-to-lung distribution ratio of ˜2.2 indicated a satisfactory colloidal stability of these NPs.

Retention of T-NPs was extremely low in the heart with a brain-to-heart ratio of 11 times indicating that although heart cells have hyperpolarized mitochondria; the lipophilic properties of the T-NPs help preferential distribution in the brain. These highly positively charged NPs demonstrated hepatobiliary excretion. The NPs accumulated in the liver can quickly get excreted into the gastrointestinal tract in comparison with negatively charged PLGA-b-PEG-COOH-NPs, which usually remain sequestered within the liver and hence the T-NPs are expected to show no toxicity upon liver accumulation.

Mitochondria-targeted NP formulation of Platin-M. Our rationale behind incorporation of a mitochondria-targeted delivery system for Platin-M was that PLGALMW-b-PEG-TPP-NPs will efficiently encapsulate hydrophobic Platin-M, increase its blood circulation, upon uptake by cancer cells with hyperpolarized ΔΨₘ, these NPs will deliver Platin-M with high accuracy and efficiency. However, any Platin-M released from the NPs prior reaching mitochondria will take advantage of the TPP moieties present on Platin-M for mitochondrial uptake. Thus, this dual targeted system will show effective mitochondrial accumulation.

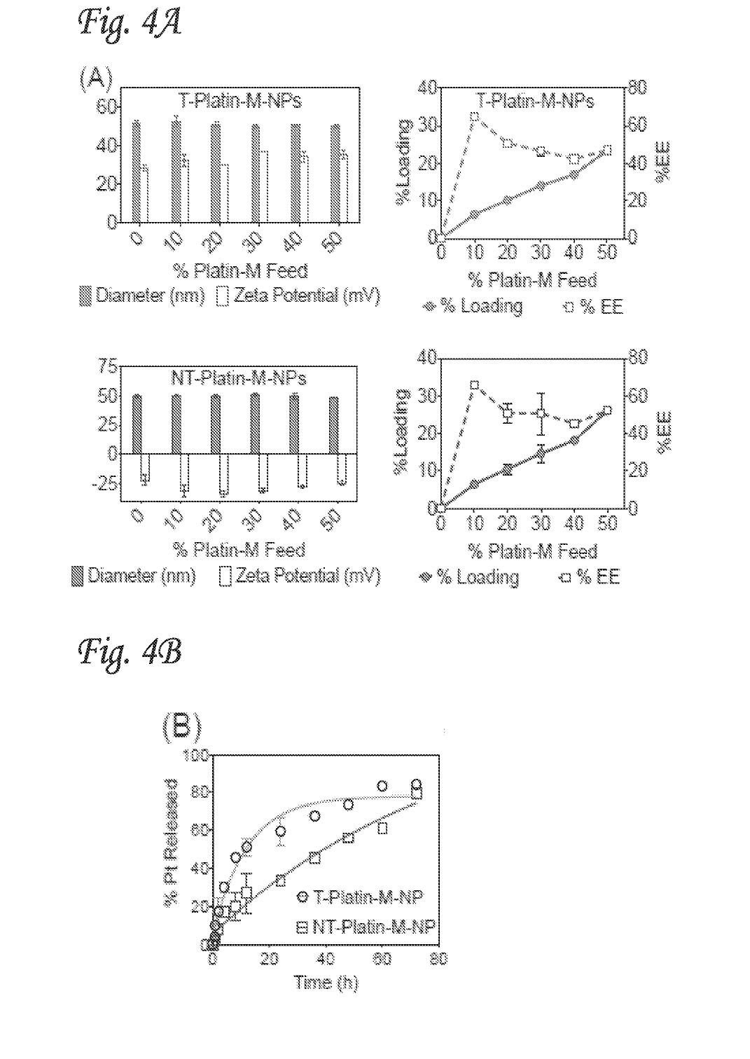

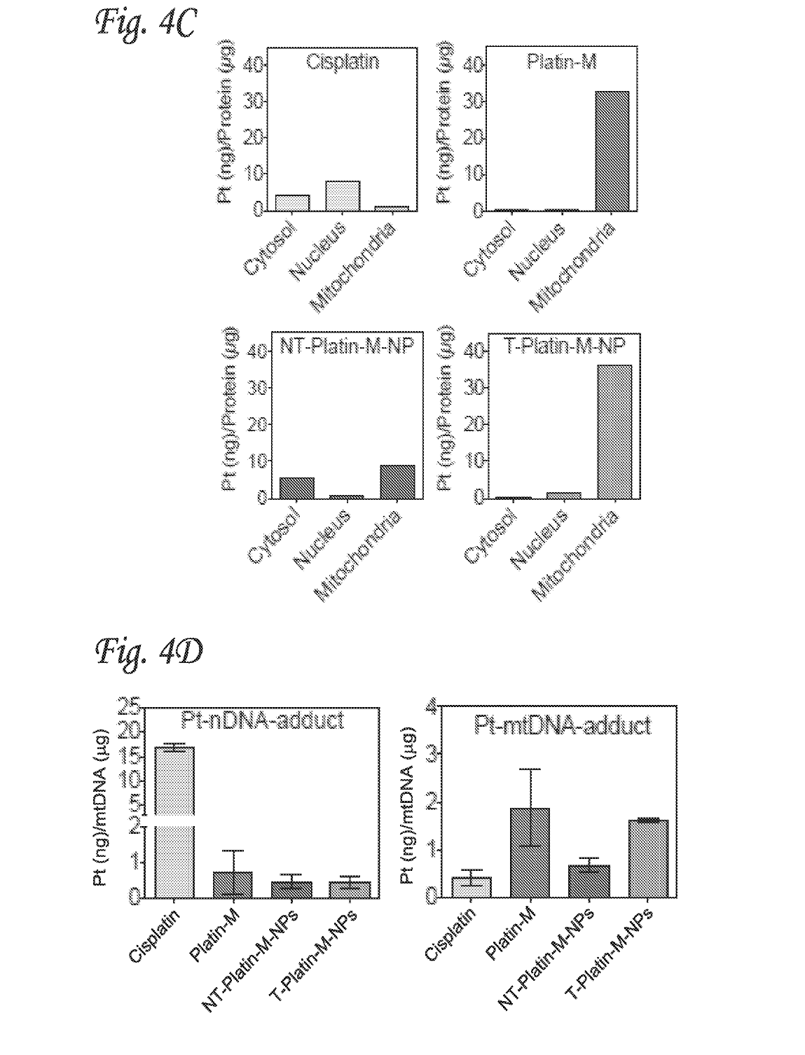

We constructed T-Platin-M-NPs by entrapping Platin-M inside PLGALMWb-PEG-TPP polymer matrix. As a single targeted control, we used Platin-M entrapped inside PLGALMW-b-PEG-OH polymer, NT-Platin-M-NPs. We used a nanoprecipitation method for entrapping Platin-M in these polymers and the NPs were characterized by dynamic light scattering (DLS) to give the size, polydispersity index (PDI), and zeta potential of each preparation (FIG. 4A, Tables S1 and S2). T-Platin-M-NPs and NT-Platin-M-NPs showed sizes in the range of 50-55 nm. T-Platin-M-NPs exhibited a highly positive zeta potential between 30 to 35 mV. Based on our previously reported mitochondria-targeted NPs, this range of sizes and zeta potential is optimized for effective mitochondria targeting.

NT-Platin-M-NPs showed a negative zeta potential of between −22 to −34 mV. Morphology of T-Platin-M and NT-Platin-M-NPs was investigated using transmission electron microscopy (TEM) (FIG. 4A). The loading efficiencies of Platin-M at various added weight-percentage values of Pt(IV) to polymer indicated that Platin-M can be entrapped in these NPs with a very high loading and encapsulation efficiency (EE) (FIG. 4A). Percent loading of Platin-M varied between 6 to 27% based on the percent feed with respect to polymer feed (FIG. 4A, Tables S1 and S2). Given the amphiphilic character of Platin-M with two cationic TPP head groups and lipophilic DBCO moieties, we questioned whether the high loading of Platin-M is due to formation of self-micelles. Nanoprecipitation of a DMF solution of Platin-M into water resulted in unstable macroparticles (Size: 941.6±589.5 nm; PDI: 0.799; Zeta Potential: −5.38±1.66 mV) leaving out such a possibility.

To the best of our knowledge, Platin-M showed the highest loading efficiency among the known platinum complexes in a PLGA-PEG-based NP system known in the literature. Release kinetics of Platin-M from T and NT-NPs under physiological pH 7.4 in phosphate buffered saline (PBS) at 37° C. demonstrated sustained release over a longer period of 72 h (FIG. 4B). A comparison of release kinetics of T and NT-NPs demonstrated that Platin-M releases from NT-NP system at a slower rate (FIG. 4B). Positively charged Platin-M released from the nontargeted NPs might get adsorb on the negatively charge NP surface and this non-covalent interaction might be responsible for slower release kinetics of Platin-M from NT-NPs.

Mitochondrial accumulation of Platin-M and NPs. Analysis of mitochondrial, cytosolic, and nuclear fractions isolated from PC3 cells treated with Platin-M, T-Platin-M-NPs, NT-Platin-M-NPs, and cisplatin showed that platinum concentration in the mitochondrial protein fraction was 30-times higher than in the nuclear protein fraction for Platin-M or its T-NP formulation compared to cisplatin (FIG. 4C). Overall uptake of cisplatin was much lower than Platin-M or its NP formulations. The non-targeted system showed only ˜8 times greater accumulation of Platin-M in the mitochondrial fraction compared to cisplatin, a significant of Platin-M from NT-Platin-M-NPs was found in the cytosolic fractions, and the overall uptake was much lower than Platin-M or its T-NPs. (FIG. 4C). This further supports our hypothesis that dual targeting will increase mitochondrial delivery efficiency of Platin-M.

Further quantification and comparison of Pt bound to nDNA and mtDNA from the treated PC3 cells indicated that cisplatin released from Platin-M and T-Platin-M-NPs exhibited binding with mtDNA (FIG. 4D). The cisplatin adduct level in the nDNA was much higher than the level of cisplatin adducts in mtDNA. Platin-M showed marginally higher mtDNA adduct compared to T-Platin-M-NP system. This might be due to the fact that for T-NP system, Platin-M needs to be released from the NPs prior to reduction to cisplatin and subsequent mtDNA interaction and all Platin-M might not have released from the NPs during the course of this experiment, mtDNA isolation was carried out after 12 h which corresponds to only ˜50% of Platin-M will be released from T-NPs (FIG. 4B).

NT-Platin-M-NPs showed reduced levels of mtDNA and nDNA adduct formation. This may be due to the slow release kinetics of Platin-M from the NT-NPs, only ˜26% of Platin-M is expected to be released in 12 h period of time (FIG. 4B).

Efficacy of Platin-M and NPs in Neuroblastoma and Cisplatin Resistant Cells. In vitro cytotoxicity of Platin-M, T-Platin-M, and NT-Platin-M was assessed by the 3-(4,5-dimethylthiazol-2-yl)-2,5-diphenyltetrazolium bromide or MTT assay on PCa PC3 cell line, human neuroblastoma SH-SY5Y cell line, and cisplatin resistant A2780/CP70 ovarian cancer cell line (Table 1). The rationale behind the use of androgen independent PC3 cell line was the inherent resistance of these cells to cisplatin therapy due to enhanced repair of Pt-nDNA adducts by the NER, poor targeting, and androgen-independent PCa with reduced normal mtDNA acquire a more progressive phenotype by inducing mutations to nDNA. Thus targeting mtDNA could lead to effective therapies for aggressive androgen independent PCa. The human neuroblastoma SH-SY5Y cell line displays several characteristics of neurons and neuronal cells typically require an increased number of mitochondria since most neuronal ATP is generated through OXPHOS. Distribution of the T-NPs in the brain and increased number of mitochondria prompted us to use SH-SY5Y cells in our studies.

To understand the effect of Platin-M on cisplatin resistant cells, we used A2780/CP70 cells with hyperpolarized mitochondria. The A2780/CP70 cell line is resistant to cisplatin and more efficient at repairing cisplatin-nDNA lesions. In all the cell lines, Platin-M and its NPs showed significant enhanced efficiency compared to cisplatin. In the resistant cells, Platin-M activity was ˜16 times better than cisplatin. Incorporation of Platin-M in T-NPs further enhanced this activity, the potency of T-Platin-M-NPs was ˜85 times better than cisplatin in the resistance cells. Incorporation of Platin-M in a non-targeted NP system shows only an increase of ˜6 times compared to cisplatin in the resistance cells.

These differences in activities between Platin-M and its mitochondria targeted and non-targeted NP formulations might be due to the differences in ΔΨₘ values of A2780/CP70, PC3, and SH-SY5Y cells. A simple OCR study on these cells using a Seahorse XF MitoStress assay supported this hypothesis (data not shown). Cisplatin resistant A2780/CP70 cells showed low basal OCR due to the hyperpolarized ΔΨₘ compared to the other two cell lines. This hyperpolarization helped Platin-M to accumulate into the matrix efficiently. Incorporation of Platin-M inside a mitochondria-targeted NP system with multiple −TPP molecules on the NP surface increased the accumulation further demonstrating an enhanced activity in the resistant cells. However, NT-Platin-M was not able to accumulate in the hyperpolarized resistant cells and high glutathione levels in the resistant cells facilitated reduction of released Platin-M to generate cisplatin in the cytosol and hence NT-Platin-MNPs showed less activity compared to Platin-M and T-Platin-M-NPs in resistant cells.

These observations further supported our rationale of using dual targeting approach for effective delivery of cisplatin inside the mitochondrial matrix. Neuroblastoma accounts for ˜15% of all childhood cancer deaths. Cisplatin is widely used to treat patients with high-risk neuroblastoma. Thus the distribution of T-NPs in the brain prompted us to explore the use of Platin-M and its NPs for possible use in neuroblastoma. We observed significantly increased activity from Platin-M in the neoroblastoma SH-SY5Y cell line compared to cisplatin. Platin-M activity in this cell line was 5.5 times higher compared to that of cisplatin. Upon encapsulation of Platin-M in T-NPs gave a response which was ˜17 times greater than the effects shown by cisplatin (Table 1). NT-Platin-M-NPs also showed enhanced activity over cisplatin. The increased efficiency of Platin-M and its NPs over cisplatin might be due to the increased number of mitochondria present in the SH-SY5Y cells. This was further supported by our data that these neuroblastoma cells showed higher OCR levels due to the presence of increased number of mitochondria (data not shown). Toxicity of Platin-M and its NPs in human mesenchymal stem cells (hMSCs) was investigated to understand the effect of these formulations in non-cancerous cells. Toxicity of Platin-M in hMSCs was found to be ˜3 times less than in the resistance cells. Incorporation of Platin-M inside the T-NPs reduced the toxicity further, T-Platin-M-NPs showed ˜5.5 times less toxicity in hMSC cells compared to the resistant cells (Table 1). This remarkable ability of Platin-M and its T-NP formulation to overcome cisplatin resistance will play significant roles in the success of this technology.

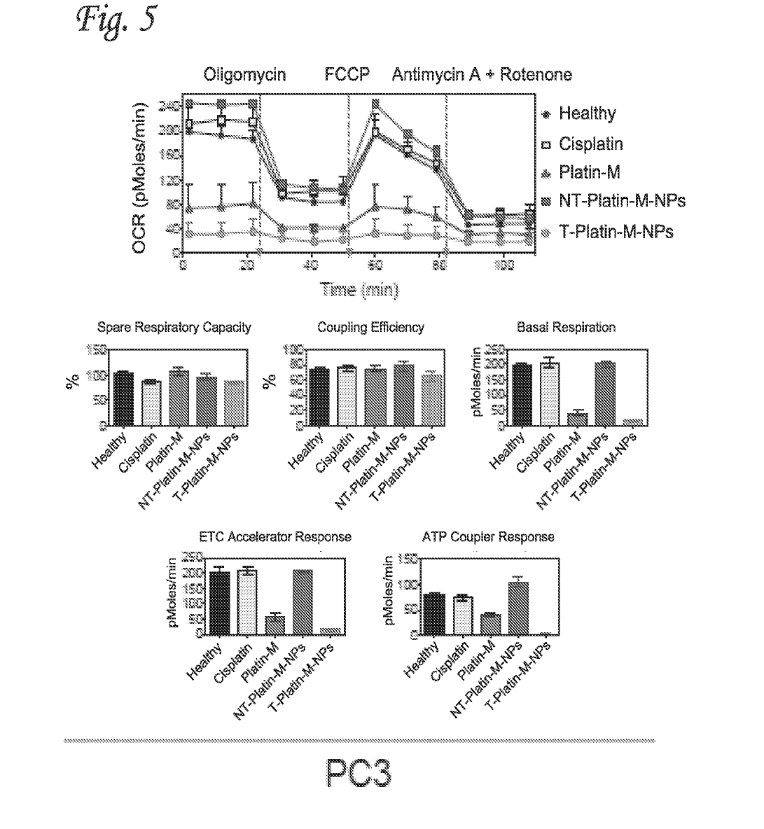

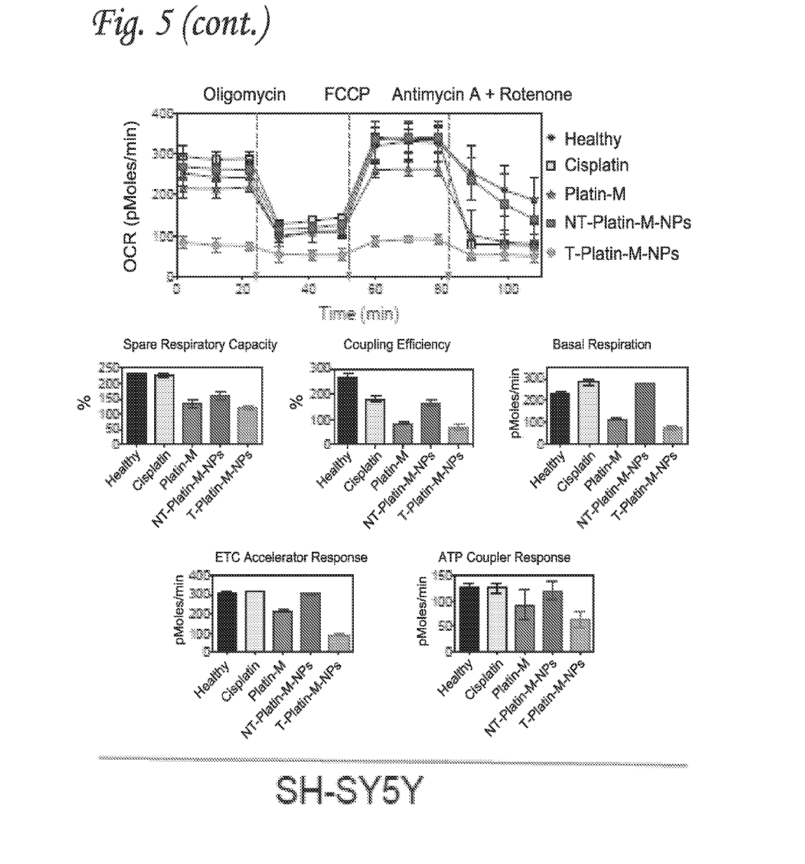

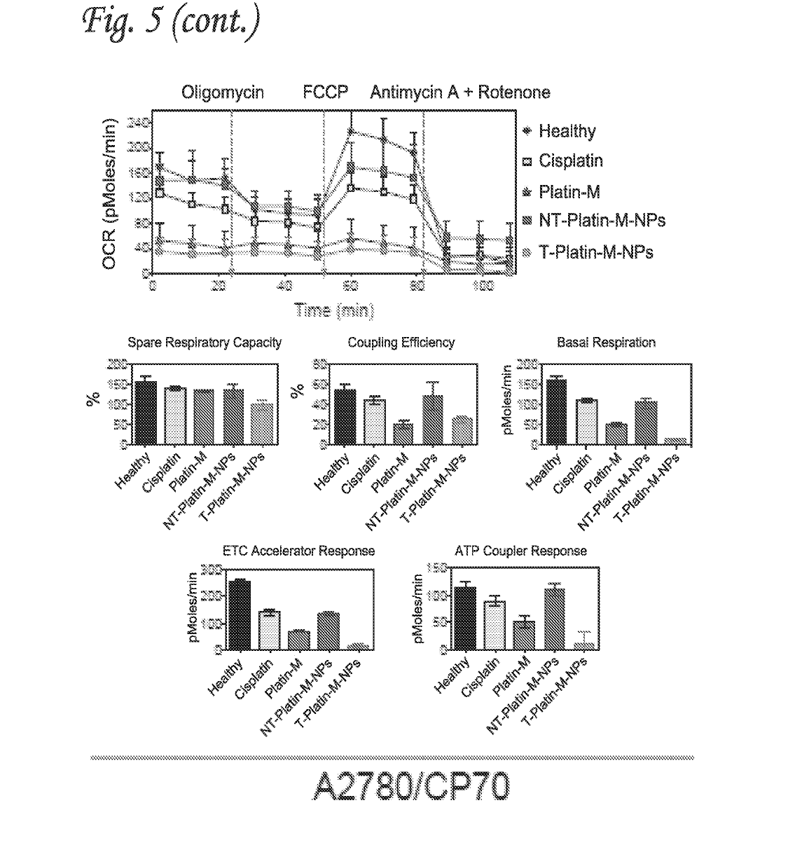

Mitochondrial Bioenergetics. We next investigated basal respiration, coupling efficiency, and spare respiratory capacity in response to Platin-M and its NPs using a XF24 MitoStress assay kit (FIG. 5). To determine whether accumulation of Platin-M inside the mitochondrial matrix of PC3 or A2780/CP70 cells inhibited mitochondrial respiration, we measured oxygen consumption rates (OCRs) in these cells as a way of assessing OXPHOS. OCR levels of PC3 cells were higher than cisplatin resistant A2780/CP70 cells indicating hyperpolarized AN., in resistance cells. PC3 or A2780/CP70 cells were treated with Platin-M, cisplatin, T-Platin-M-NPs, NT-Platin-M-NPs for 12 h.

The basal OCR levels of Platin-M or T-Platin-M-NP treated cells were found to be less than control cells, indicating a loss in total mitochondrial mass. However, cisplatin did not show any changes (FIG. 5). The ATP synthase inhibitor oligomycin was injected to evaluate mitochondrial coupling upon accumulation of Platin-M inside the mitochondria in these cells. Addition of oligomycin showed that the levels of ATP-linked respiration were attenuated in control cells or cells treated with cisplatin, NT-Platin-M-NPs; Platin-M treated cells showed less reduction, and T-Platin-M-NPs did not show any significant changes. To determine the maximal respiratory capacity, a mitochondrial uncoupler p-triflouromethoxyphenylhydrazone (FCCP) was injected into the media. The stimulation of mitochondrial respiration with FCCP after oligomycin was comparable for cisplatin, NT-Platin-M-NPs and control cells, but Platin-M or T-Platin-M-NPs showed no enhancement in OCR levels.

Finally, injection of a combination of mitochondrial complex III inhibitor antimycin A and mitochondrial complex I inhibitor rotenone significantly inhibited the OCR due to the formation of mitochondrial ROS and non-mitochondrial O₂ consumption. Overall, Platin-M and T-Platin-M-NPs showed inhibition of mitochondrial respiration in A2780/CP70 cells to a greater extent compared to the PC3 cells. This mitochondrial respiration programming by Platin-M and its T-NPs indicated enormous potential of the current technology in the treatment of chemo-resistance tumor with inherently hyperpolarized mitochondria and of neuroblastoma with increased number of mitochondria present in these cells. Keeping in mind that heart cells contain hyperpolarized mitochondria, we looked at the toxicity of mitochondria accumulating Empty-T-NPs in cardiomyocytes (data not shown).

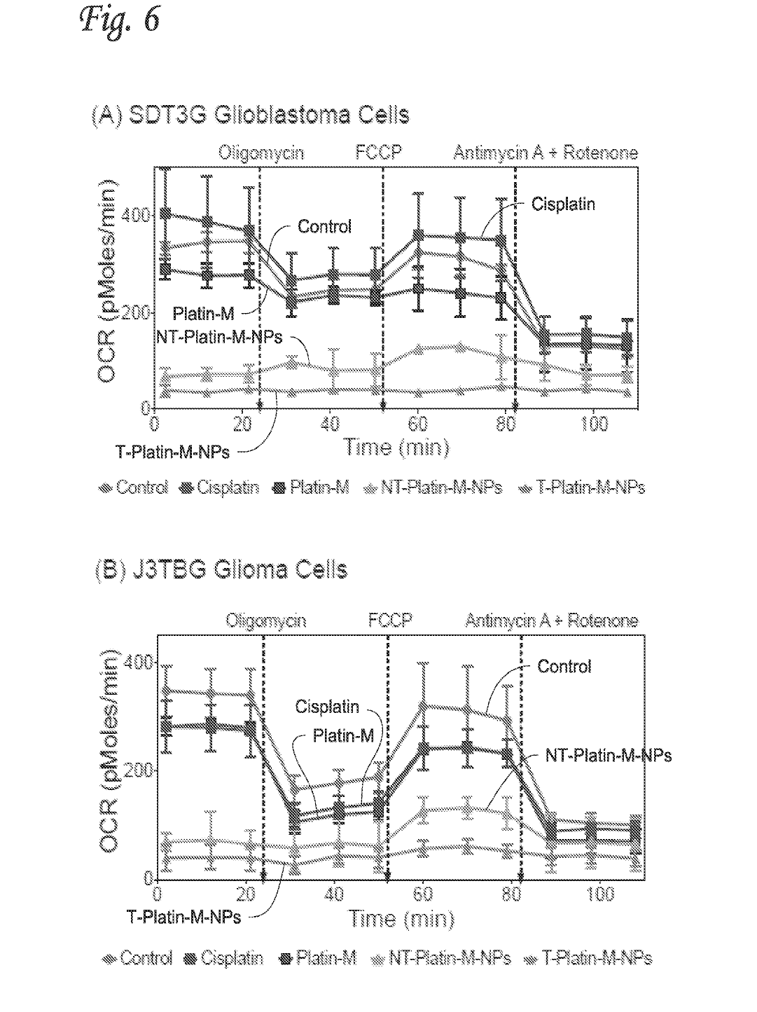

Effects of cisplatin, Platin-M, NT-Platin-M-NPs, and T-Platin-M-NPs on H9C2 cardiomyocytes under identical conditions as mentioned for other cell lines showed similar trend as observed with other cell lines (data not shown). In addition, effects of cisplatin, Platin-M, NT-Platin-M-NPs, and T-Platin-M-NPs on two canine brain tumor cell lines, SDT3G glioblastoma cells and J3TBG glioma cells, under identical conditions as mentioned for other cell lines showed similar trend as observed with other cell lines (FIG. 6).

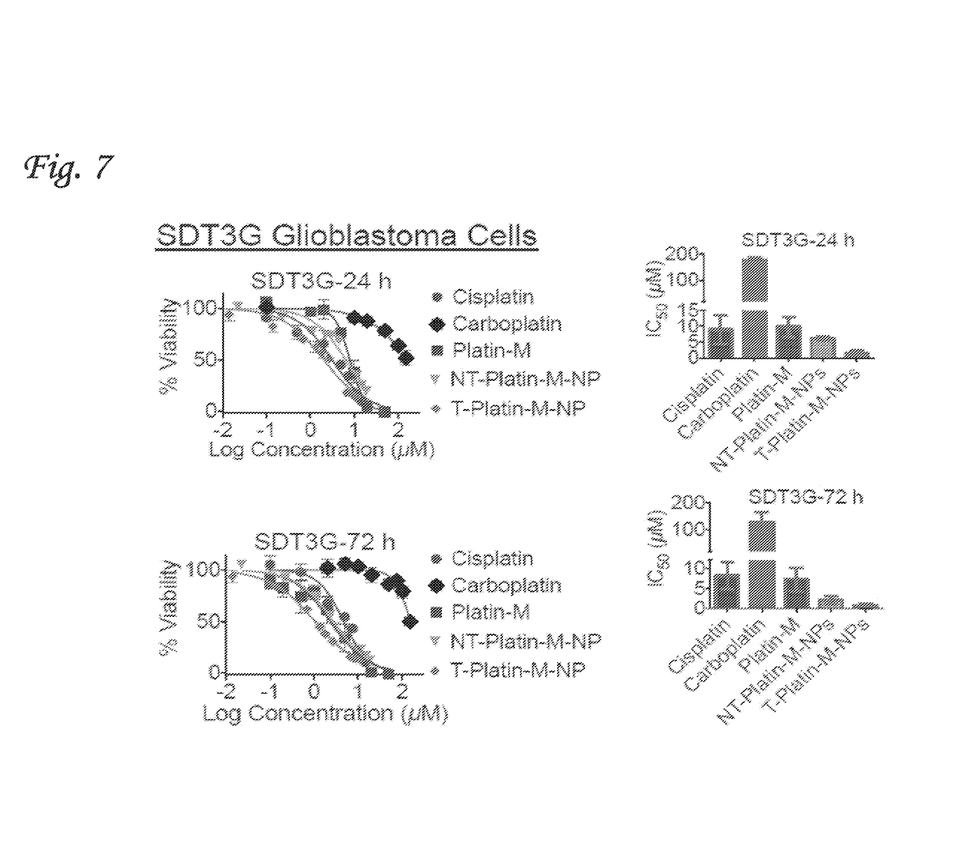

We compared the in vitro efficacy of T-Platin-M-NPs to that of cisplatin, carboplatin, Platin-M, and NT-Platin-M-NPs in canine brain tumor cell line SDT3G. Cell viability was assessed by the (3-(4,5-dimethylthiazol-2-yl)-2,5-diphenyltetrazolium bromide) tetrazolium reduction (MTT) assay after treatment with the indicated concentrations of the test articles for 48 or 72 h. For all NP treatments, media was changed after 12 h and cells were further incubated for 36 or 60 h. The data presented in FIG. 7 are mean ±SD (n=3 wells). The IC50 values are presented as average from three independent experiments (FIG. 7). As shown in FIG. 7, the nanoparticles, particularly the targeted nanoparticles (T-Platin-M-NPs) has substantially lower IC50 values that cisplatin.

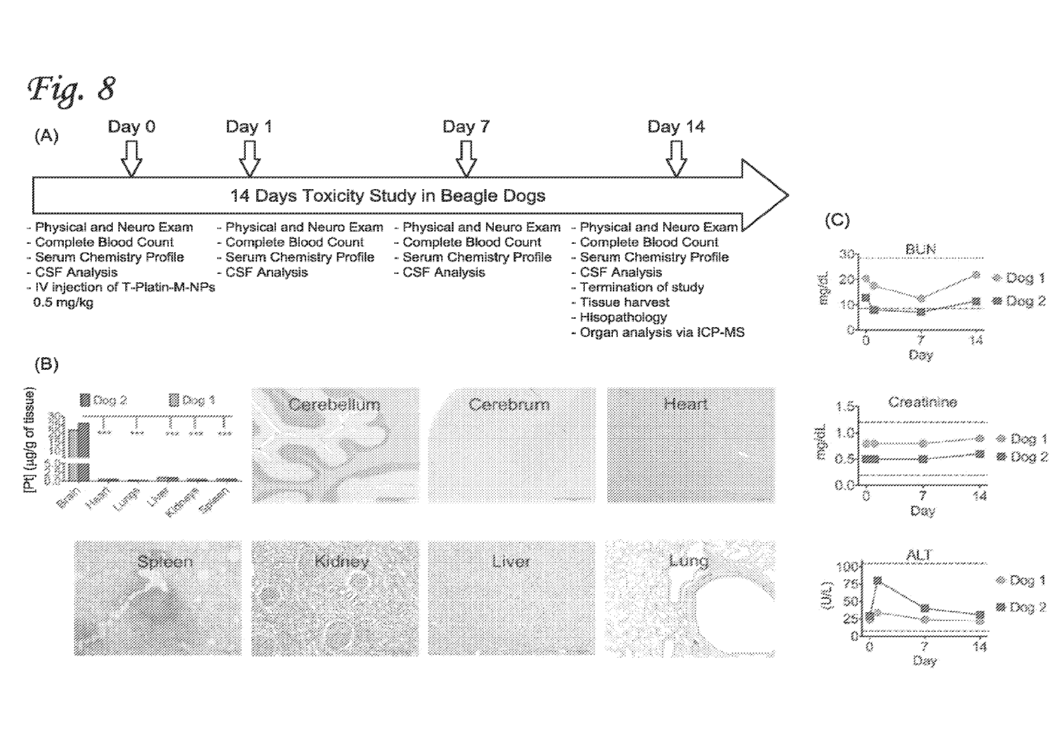

Biodistribution and safety of T-Platin-M-NPs was tested in beagle dogs. Two beagle dogs were subjected to a physical and neurological examination, complete blood count, serum chemistry profile, and cerebrospinal fluid (CSF) analysis on day zero prior to single IV administration of 0.5 mg/kg T-Platin-M-NPs (with respect to Platin-M). On days 1, 7 and 14, the dogs were subjected to a physical and neurological examination, complete blood count, serum chemistry profile, and CSF analysis. On day 14, the study was terminated, tissues were harvested, histopathology performed and organs were analyzed via inductively coupled plasma—mass spectrometry (ICP-MS). A graphical representation of the study design is presented in FIG. 8(A). FIG. 8(B) shows platinum concentration in organs 14 days after the single intravenous injection of T-Platin-M-NP beagles and representative images for Day 14 post-injection histopathology of cerebellum, cerebrum, heart, lung, liver, kidney, and spleen. No changes related to the T-Platin-M-NPs injection were observed. FIG. 8(C) shows that blood urea nitrogen (BUN), creatinine, and alanine aminotransferase (ALT) values for both dogs remained within clinically acceptable limits for the duration of the study.

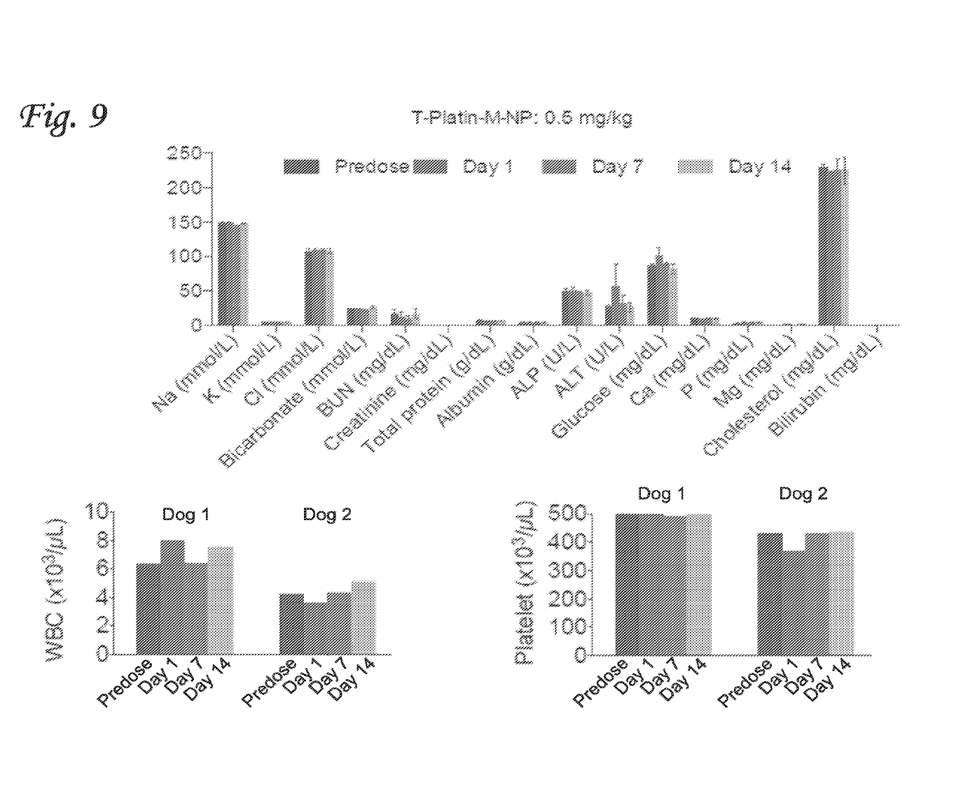

FIG. 9 shows complete clinical chemistry and some hematology data from safety and bioD studies with T-Platin-M-NPs with a dose of 0.5 mg/kg in two female dogs for a period of 14 days (as described above).

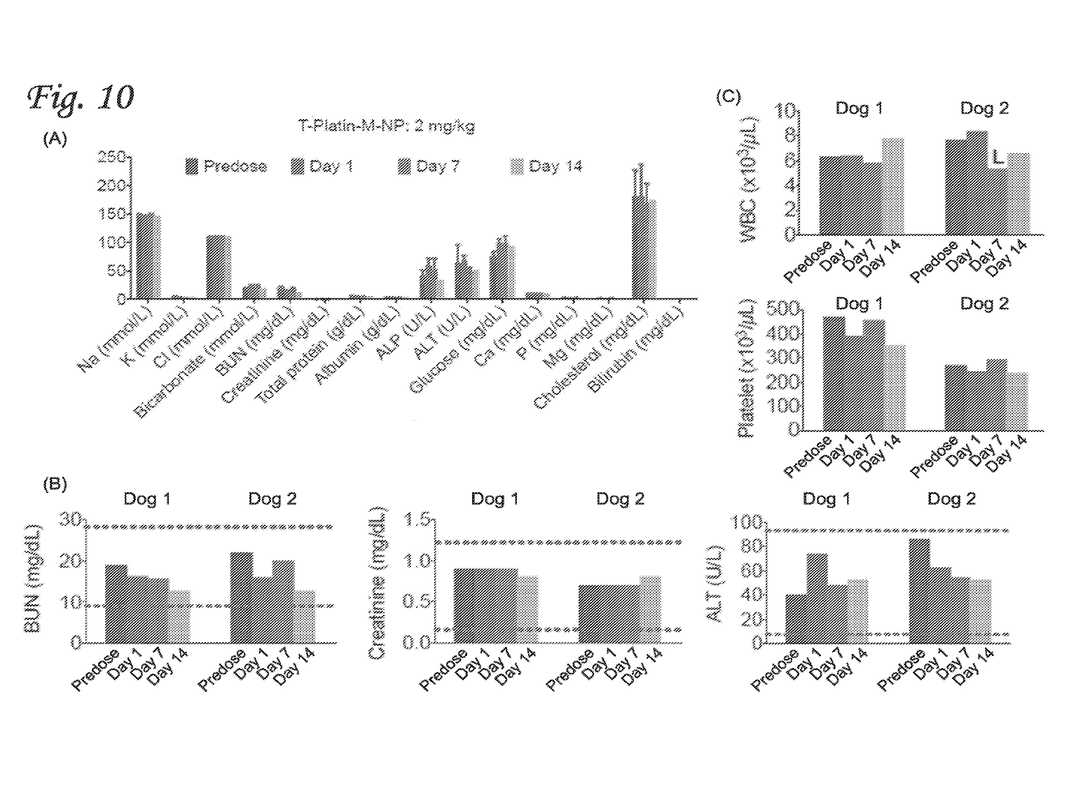

FIG. 10(A) shows (A) Complete serum chemistry results predose, day 1, day 7, and day 14 after single intravenous injection of T-Platin-M-NPs with 2 mg/kg in two male beagles (as described above, but with higher concentration of T-Platin-M-NPs). FIG. 10(B) shows BUN, creatinine, and ALT values for both dogs during the period of this study; and FIG. 10(C) shows the white blood cell (WBC) and platelet counts from the two beagles during the course of the study (L: Low).

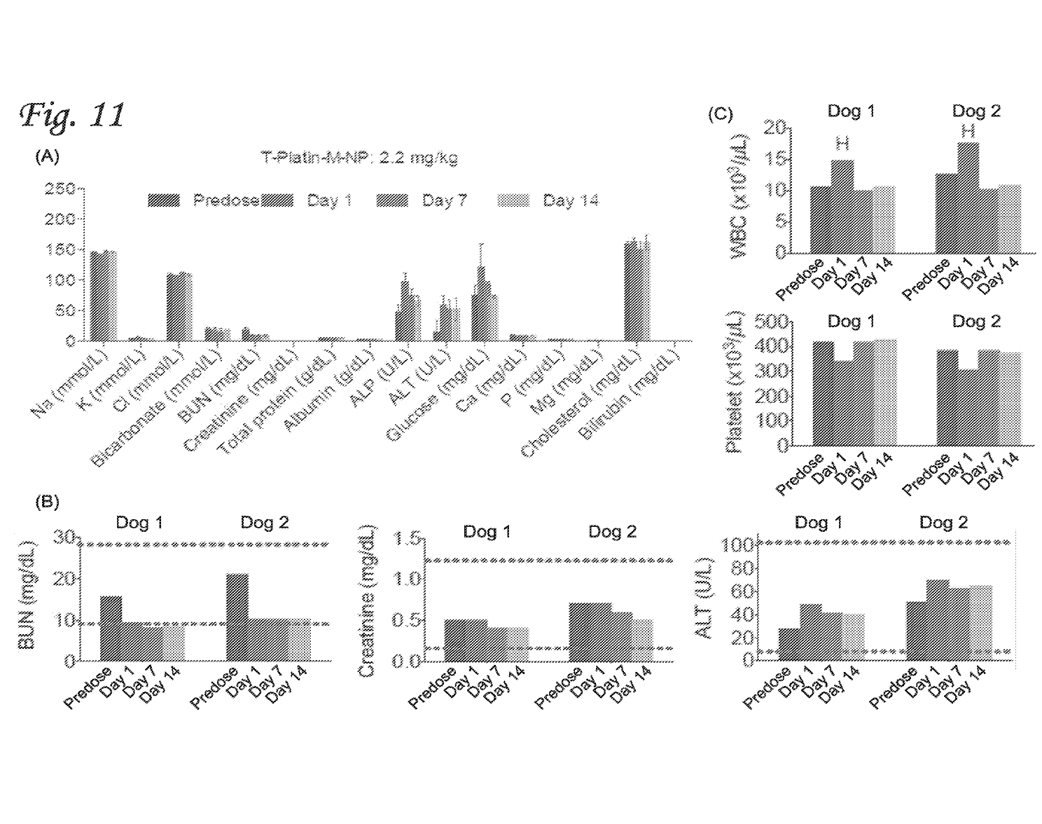

FIG. 11(A) shows complete serum chemistry results predose, day 1, day 7, and day 14 after single intravenous injection of T-Platin-M-NPs with 2.2 mg/kg in two male beagles (as described above, but with higher concentration of T-Platin-M-NPs). FIG. 11(B) shows BUN, creatinine, and ALT values for both dogs during the period of this study; and FIG. 11(C) shows WBC and platelet counts from the two beagles during the course of the study (H: High).

Here, we outlined a strategy for designing mitochondrial delivery of cisplatin for chemoresistance aggressive cancers-from construction of a mitochondria targeted cisplatin prodrug to its formulation in a targeted delivery vehicle-that can be implemented in cisplatin resistance settings and in cancers of central nervous system. These studies represent an initial development of previously undescribed routes for cisplatin-based therapy. Since most late stage cancers are resistant to cisplatin treatment because of the development of chemo-resistance, therefore, delivery of cisplatin inside the mitochondrial matrix to attack mtDNA lacking NER using a targeted NP, as outlined here, can be extremely beneficial in providing a new therapeutic strategy to tackle otherwise resistant advanced cancers.

### Materials and Methods

To the extent not described above, the following describes materials and methods for the testing presented in the EXAMPLES.

Materials and Instrumentations: All chemicals were received and used without further purification unless otherwise noted. Cisplatin was purchased from Strem Chemicals, Inc. Dimethylaminopyridine (DMAP), K2PtCl4, 2′-deoxyguanosine 5′-monophosphate sodium salt hydrate (5′-dGMP), and sodium ascorbate, KCl , N-hydroxysuccinimide (NHS), triethylamine, 5-bromopentanoic acid, 6-bromohexanoic acid, sodium azide, N,N′-dicyclohexylcarbodiimide (DCC), hydrogen peroxide solution (30 wt. % in H₂O), (3-(4,5-dimethylthiazol-2-yl)-2,5-diphenyltetrazolium bromide (MTT) were purchased from Sigma-Aldrich. Dibenzocyclooctynes (DBCO)-amine (Product No. A103) was procured from Click chemistry Tools Bioconjugate Technology Company. Carboxy terminated (dL/g, 0.15 to 0.25 and 0.55 to 0.75) was procured from Lactel and OH-PEG-OH of molecular weight 3350 was purchased from Sigma Aldrich. Triphenyphosphine (TPP) was purchased from Sigma Aldrich. Bicinchoninic acid (BCA) protein assay kit (Pierce 23227) was purchased from Thermo Scientific. The mitochondrial isolation kit (catalog number PI-89874) for mammalian cells was purchased from Thermo Scientific. Tris(hydroxymethyl)aminomethane was purchased from Fischer Scientific. Sodium chloride, magnesium chloride, sucrose, potassium chloride, and ethylyenediaminetetraacetic acid (EDTA) were purchased from J. T. Baker. Oligomycin, rotenone, antimycin-A and trifluorocarbonylcyanide phenylhydrazonen (FCCP) were purchased from Sigma Aldrich. The protease inhibitor cocktail was purchased from Sigma Aldrich. Slide-A-Lyzer MINI Dialysis Units (catalog number 69572) were purchased from Thermo Scientific. The mitochondrial DNA isolation Kit (ab65321) and genomic DNA isolation kit (ab65358) were purchased from Abcam. Distilled water was purified by passage through a Millipore Milli-Q Biocel water purification system (18.2 MΩ) containing a 0.22 μm filter. 1H, 13C spectra were recorded on a 400 MHz; 31P NMR and 195Pt NMR spectra recorded on a 500 MHz Varian NMR spectrometer, respectively. Electrospray ionization mass spectrometry (ESI-MS) and high-resolution mass spectrometry (HRMS)-ESI were recorded on Perkin Elmer SCIEX API 1 plus and Thermo scientific ORBITRAP ELITE instruments, respectively.

Electrochemical measurements were made at 25° C. on an analytical system model CHI 920c potentiostat from CH Instruments, Inc. (Austin, Tex.). Cells were counted using Countess® Automated Cell Counter procured from Invitrogen life technology. Dynamic light scattering (DLS) measurements were carried out using a Malvern Zetasizer Nano ZS system. Optical measurements were carried out on a NanoDrop 2000 spectrophotometer. Transmission electron microscopy (TEM) images were acquired using a Philips/FET Technai 20 microscope. Inductively coupled plasma mass spectrometry (ICP-MS) studies were performed on a VG PlasmaQuad 3 ICP mass spectrometer. Plate reader analyses were performed on a Bio-Tek Synergy HT microplate reader. Gel permeation chromatographic (GPC) analyses were performed on Shimadzu LC20-AD prominence liquid chromatographer equipped with a refractive index detector and Waters columns; molecular weights were calculated using a conventional calibration curve constructed from narrow polystyrene standards using tetrahydrofuran (THF) as an eluent at a temperature of 40° C. Bioenergetic assays were carried out using a Seahorse XF24 analyzer (Seahorse Biosciences, North Billerica, Mass., USA). Fluorescent imaging of cellular components was carried out on a Xenogen IVIS® Lumina system.

Cell Lines and Cell Culture: Human prostate cancer cell line PC3 and neuroblastoma SH-SY5Y cells were procured from the American type culture collection (ATCC). Cisplatin resistant human ovarian carcinoma cell line A2780/CP70 was kindly provided by Thomas Hamilton (Fox Chase Cancer Center, Jenkintown, Pa.). Human bone marrow derived MSCs were purchased from Lonza. H9C2 cardiomyocytes was given as a generous gift from Prof Mark Anderson, University of Iowa. The cardiomyocytes were grown in 89% Dulbecco's Modified Eagle's Medium (DMEM) supplemented with 4 mM L-glutamine, 1.5 g/L sodium pyruvate, 4.5 g/L glucose, 1% penicillin/streptomycin, and 10% fetal bovine serum. PC3 and A2780/CP70 cells were grown at 37° C. in 5% CO2 in Roswell Park Memorial Institute (RPMI) 1640 medium supplemented with 10% FBS, 1% penicillin/streptomycin, sodium pyruvate (100 mM), HEPES buffer solution (1 M), and Lglutamine (200 mM). SH-SY5Y cells were cultured in DMEM supplemented with 10% FBS and 1% penicillin/streptomycin. Human MSCs were grown in mesenchymal stem cell basal medium supplemented with 2% FBS, 1% penicillin/streptomycin, recombinant human fibroblast growth factor-basic (5 ng/mL), recombinant human fibroblast growth factor-acidic (5 ng/mL), and recombinant human epithelial growth factor (5 ng/mL). Cells were passed every 3 to 4 days and restarted from frozen stocks upon reaching pass number 20 for PC3, SH-SY5Y, A2780/CP70, H9C2 cells and 10 for MSC.

Synthesis of DBCO-TPP: A mixture of TPP-(CH₂)₅—COOH (1) (250 mg, 0.55 mmol) and NHS (75.40 mg, 0.66 mmol) in dry CH₂Cl₂ was stirred for 30 min at 0° C. A solution of DCC (124 mg, 0.6 mmol) in CH₂Cl₂ was added drop wise to the reaction mixture. The reaction was stirred from 0° C. to room temperature for 12 h. The precipitated N,N′-dicyclohexylurea (DCU) by-product was filtered off and the solution was evaporated using rotavap. This residue was dissolved in dry CH₂Cl₂. A solution of triethylamine (66.27 mg, 0.66 mmol) and DBCO-NH₂ (181 mg, 0.66 mmol) in CH₂Cl₂ was added slowly to the above reaction mixture. This reaction mixture was kept at room temperature for 24 h with vigorous stirring. The solvent was evaporated to dryness. The residue was dissolved in CH₂Cl₂ and precipitated with diethyl ether (CH₂Cl₂:diethyl ether: 1:9). This process was repeated 5 times. Finally the product was purified by precipitating through (CH₂Cl₂:ethanol:diethyl ether=1:1:8) solvent mixture. Yield, 266 mg, 68%. 1H NMR (CDCl₃, 400 MHz): δ 7.67-7.75 (m, 15H), 7.23-7.33 (m, 8H), 6.83 (t, 1H), 5.12 (d, 1H), 3.64 (m, 3H), 3.20 (t, 2H), 2.51 (m, 1H), 2.03 (t, 2H), 1.95 (m, 1H), 1.58 (m, 6H) (FIG. S1) ppm. ¹³C NMR (CDCl₃, 100 MHz): δ 172.94, 171.86, 151.17, 148.02, 134.98, 135.01, 133.67, 133.57, 133.53, 132.13, 130.60, 130.53, 130.40, 129.28, 128.69, 128.18, 128.13, 127.79, 127.01, 125.51, 123.00, 122.31, 118.69, 117.84, 114.74, 107.88, 65.82, 55.39, 35.85, 35.29, 34.65, 29.73, 29.56, 25.48, 24.62, 22.75, 22.25, 22.05, 22.01, 15.24 ppm (FIG. S2). 31 P NMR (CDCl3) δ 24.65 ppm (FIG. S3). HRMS-ESI (m/z): [M-Br]+calcd. for C₄₂B₄₀N₂O₂P⁺, 635.2822; found, 635.2823 (FIG. S4).

Synthesis of Platin-M: A solution of Platin-Az (60 mg, 0.098 mmol) and DBCO-TPP (140 mg, 0.196 mmol) in 10 mL of dry dimethylformamide (DMF) was stirred at room temperature for 12 h. This reaction mixture was concentrated and the product was precipitated using diethyl ether. The crude product was suspended in CH₂Cl₂ and CH₃CN and precipitated with diethyl ether. Finally the product was isolated through precipitation with CH₂Cl₂:CH₃CN:diethyl ether (1:1:8) to get a light yellow solid. Yield, 140 mg, 71%. 1H NMR (DMSO-d₆, 400 MHz): δ 7.78-7.90 (m, 30H), 7.27-7.66 (m, 18H), 6.57 (broad, 6H), 5.86-5.97 (m, 2H), 4.43-4.47 (m, 2H), 4.20-4.38 (m, 4H), 3.30 and 3.56 (m, 4H), 2.87-2.99 (m, 4H), 2.14-2.21 (m, 4H), 1.92 (m, 4H), 1.83 (m, 2H), 1.39-1.50 (m, 24H), 1.01-1.10 (m, 2H) ppm (FIG. S5), gCOSY (FIG. S6). ¹³C NMR (CDCl₃, 100 MHz): δδ 181.16, 181.13, 172.25, 172.08, 170.14, 169.79, 144.18, 142.64, 141.34, 140.46, 135.78, 135.33, 135.31, 134.27, 134.21, 134.08, 133.98, 132.36, 132.03, 131.72, 131.11, 130.74, 130.72, 130.62, 130.29, 129.98, 129.59, 129.11, 128.72, 127.94, 127.28, 124.70, 119.42, 119.40, 118.57, 118.55, 55.39, 52.26, 51.02, 48.89, 48.19, 40.60, 40.39, 40.18, 39.98, 39.77, 39.56, 39.35, 35.96, 35.70, 35.24, 35.18, 35.07, 33.91, 30.01, 29.84, 29.54, 28.48, 26.27, 26.16, 25.54, 25.40, 25.36, 25.19, 24.83, 24.72, 22.10, 20.86, 20.36 ppm (FIG. S7). ³¹P NMR (CDCl₃) δ 24.10 ppm (FIG. S8). ¹⁹⁵Pt (DMSO-d₆, 107.6 MHz) δ 1108.94 ppm (FIG. S9). HRMS m/z Calcd. For C₉₆H₁₀₆Cl₂N₁₂O₈P₂Pt²⁺: (M)²⁺941.3390. Found 941.3378 (FIG. S10). Elemental analysis calcd (%) for C₉₆H₁₀₆Br₂Cl₂N₁₂O₈P₂Pt.CH₃CN.CH₂Cl₂.H₂O: C 54.35, H 5.21, N 8.32; found: C 54.10, H 5.44, N 8.55.

Electrochemistry of Platin-M: Electrochemical measurements were made at 25° C. on an analytical system model CHI 920c potentiostat from CH Instruments, Inc. (Austin, Tex.). A conventional three-electrode set-up comprising a glassy carbon working electrode, platinum wire auxiliary electrode, and an Ag/AgCl (3M KCl) reference electrode was used for electrochemical measurements. The electrochemical data were uncorrected for junction potentials. KCl was used as a supporting electrolyte. Platin-M (1 mM) solutions were prepared in 20% DMF-phosphate buffered saline (PBS) of pH 6.0 and 7.4 with 0.1 M KCl and voltammograms were recorded at different scan rates (data not shown). Redox potentials of Platin-M at pH 7.4 was found to be −0.376 V vs. Ag/AgCl:−0.275 vs. NHE and at pH 6.0 was found to be −0.369 V vs. Ag/AgCl; −0.269 vs. NHE.

Determination of Platin-M Ability to Form Micelles: Platin-M was dissolved in DMF to a final concentration of 1.5 mg/mL. This solution was added drop wise slowly into vigorously stirring nanopure water (10 mL) and stirred at room temperature for 3 h. This solution was then filtered and washed through Amicon filters with a MW cutoff of 100 kDa 3 times in order to ensure the removal of all residual organic solvent. Finally, the NPs were resuspended in nanopure water (1 mL) and filtered through a 0.2 μm filter. The resulting suspension was characterized by DLS.

Synthesis of PLGA_{LMW}-b-PEG-OH and PLGA_{LMW}-b-PEG-TPP: These two polymers were synthesized following methods previously reported by us (Marrache S. and Dhar S. (2012) Proc Natl Acad Sci USA 109:16288-16293). Spectral Data for PLGA_{LMW}-b-PEG-OH (FIG. S12): ¹H NMR (CDCl₃, 400 MHz): δ 5.3 [m, 43H (OCHCH₃C(O)], 4.9 [m, 86H (OCH₂C(O)], 3.6 [s, 119H (OCH₂)], 1.9 [m, 132H (CH₃CH)] ppm. ¹³C NMR (CDCl₃, 400 MHz): δ 169.8, 166.1, 70.5, 69.3, 61.1, 15.46 ppm. Spectral Data for PLGA_{LMW}-b-PEG-TPP (FIG. S13): ¹H NMR (CDCl₃, 400 MHz): δ 5.3 [m, 604H (OCHCH₃C(O)], 4.9 [m, 1194H (OCH₂C(O)], 3.6 [s, 197H (OCH₂)], 1.9 [m, 1960H (CH₃CH)] ppm. ¹³C NMR (CDCl₃, 100 MHz): δ 169.8, 166.1, 70.5, 69.3, 61.1, 15.46 ppm. ³¹P NMR (CDCl₃, 100 MHz): δ 24.6 ppm. GPC: Mn=14,420 g/mol, Mw=17,030 g/mol, Mz=20,320 g/mol, PDI=1.18 (FIG. S16).

Synthesis of PLGA_{HMW}-b-PEG-OH: OH-PEG-OH (3.75 g, 1.1 mmol), PLGA-COOH (inherent viscosity of 0.55-0.75, 5.0 g, 0.38 mmol), and DMAP (0.045 g, 0.38 mmol) were dissolved in dry CH₂Cl₂ (50 mL). The reaction mixture was cooled to 0° C. while stirring. DCC (0.2 g, 1.1 mmol) was dissolved in CH₂Cl₂ (3 mL) and added drop wise to the polymer solution. The mixture was then warmed to room temperature and stirred overnight. Afterwards, DCU was filtered out and the resulting mixture was precipitated in a 50:50 mixture of cold diethyl ether:methanol (200 mL), repeatedly. The resulting solid was centrifuged at 5000 rpm for 10 min. The resulting solid was frozen and lyophilized overnight to produce the polymer with a 41% yield. Final product was analyzed by NMR and GPC. ¹H NMR (CDCl₃, 400 MHz): δ 5.3 [m, 604 H (OCHCH₃C(O)], 4.9 [m, 1194H (OCH₂C(O)], 3.6 [s, 197H (OCH₂)], 1.9 [m, 1960 H (CH₃CH)] ppm (FIG. S14). ¹³C NMR (CDCl₃, 400 MHz): δ 169.6, 166.5, 66.0, 61.1, 60.9, 16.89, 15.46 ppm (FIG. S14). GPC: Mn=47,280 g/mol, Mw=68,210 g/mol, Mz=92,900 g/mol, PDI=1.36 (FIG. S16).

Synthesis of PLGA_{HMW}-b-PEG-TPP: PLGA_{HMW}-b-PEG-OH (1 g, 0.02 mmol), TPP-(CH₂)₄—COOH (0.045 g, 0.12 mmol), and DMAP (0.010 g, 0.08 mmol) were dissolved in CH2Cl2 for 30 min at 0° C. A solution of DCC (12 mg, 0.06 mmol) was added drop wise. The solution was slowly returned to room temperature and stirred for 12 h. The resulting DCU was removed via gravity filtration. CH₂Cl₂ was removed in vacuo and the resulting polymer was dissolved in a 50:50 mixture of CH₂Cl₂/MeOH and precipitated with diethyl ether. The resulting solid was isolated by centrifugation (5000 rpm, 10 min, 4° C.) This process was repeated 4 times in order to remove the residual TPP-(CH₂)₄—COOH. Finally, the resulting polymer was frozen and lyophilized overnight to produce the targeted polymer with a 59% yield. ¹H NMR (CDCl₃, 400 MHz): δ 7.6-7.7 [m, 15H, (PPh₃)], 5.3 [m, 657H (OCHCH₃C(O)], 4.9 [m, 1278H (OCH₂C(O)], 3.6 [s, 197H (OCH₂)], 1.9 [m, 2068H (CH₃CH)] ppm (FIG. S15). ¹³C NMR (CDCl₃, 400 MHz): δ 169.6, 166.5, 66.0, 61.1, 60.9, 16.89, 15.46 ppm (FIG. S15). ³¹P NMR (CDCl₃, 100 MHz): δ 24.8 ppm (FIG. S15). GPC: Mn=54,510 g/mol, Mw=73,510 g/mol, Mz=94,380 g/mol, PDI=1.35 (FIG. S16).

Preparation of Platin-M Encapsulated PLGA-b-PEG Polymeric Nanoparticles (NPs): Platin-M encapsulated targeted NPs (T-Platin-M-NP) and non-targeted (NT-Platin-M-NP) NPs were prepared by a nanoprecipitation method. Briefly, PLGA-b-PEGTPP (Marrache and Dhar, supra) or PLGA-PEG-OH were dissolved in DMF (50 mg/mL). Varying amounts of Platin-M (10 mg/mL in DMF) were added to the PLGA-b-PEG-TPP or PLGA-b-PEG-OH solution to a final polymer solution of 5 mg/mL. This was added drop-wise slowly into vigorously stirring nanopure water (10 mL) and stirred at room temperature for 3 h. This solution was then filtered and washed through centrifugal filters with a MW cutoff of 100 kDa 3 times in order to ensure the removal of all residual organic solvent. Finally, the NPs were resuspended in nanopure water (1 mL) and filtered through a 0.2 μm filter. The NPs were characterized by DLS (Tables S1and S2) for size and zeta potentials and the amount of Platin-M encapsulated was analyzed by ICP-MS (Tables S1and S2).

Preparation of PLGA-PEG-QD Encapsulated PLGA-b-PEG-TPP-NPs: PLGA-b-PEGTPP-NPs encapsulated with PLGA-PEG-QD (Marrache and Dhar, supra) were synthesized using nanoprecipitation method. A solution of PLGA-b-PEG-TPP (5 mg/mL in DMF) and PLGA-PEG-QD (10 μL, 8 μM in DMF) was added drop wise to vigorously stirring water. The NPs were stirred for 2 h. Organic solvent was removed by 3 washes using centrifugal filters with a 100 kDa cut-off NPs were resuspended in nanopure water.

Release Kinetics of Platin-M from NPs: In order to observe the rate at which the Platin-M was released from the NP core, release kinetics of T-Platin-M-NPs and NTPlatin-M-NPs were analyzed. The NPs (T or NT) were synthesized according to the method above. The resulting NPs were subjected to dialysis via using Slide-A-Lyzer Mini dialysis devices with a 100 kDa MW cutoff of in 1× PBS at physiological conditions (pH 7.4, 37° C.). PBS was changed every 12 h. At different time points, the dialysis bag was removed and the amount of Platin-M remaining in the polymeric core was analyzed by ICP-MS.

Cellular Fractionation of Platin-M-NPs, Platin-M, and Cisplatin Treated Cells: Platin-M, T-Platin-M-NPs, NT-Platin-M-NPs, and cisplatin (1 μM with respect to Pt) were internalized in PC3 cells (1.0×10⁶ cells/mL in 15 mL) for 12 h. After internalization, the mitochondria and the cytosol were isolated using a mitochondria isolation kit for mammalian cells. Cells were isolated by trypsinization and washed 3× with 1× PBS. Reagent A supplemented with protease inhibitors (10 mg/mL) was added followed by incubation on ice for 2 min. Reagent B was added and incubated on ice for 5 min with gentle vortexing every min. Following this, reagent C was added and cells were centrifuged (700×g at 4° C. for 10 min). The resulting pellet yielded the nuclei and cellular debris. The supernatant, containing the cytosolic and mitochondrial fractions, was removed and further centrifuged (12,000×g at 4° C. for 15 min). The resulting supernatant contained the cytosolic fraction and the pellet contained the impure mitochondrial fraction. This was further purified by washing with reagent C and centrifuged (12,000×g at 4° C. for 5 min). The isolated nucleus and cellular debris was further fractionated in order to obtain a pure nuclear fraction. The pellet was resuspended in 600 μL of a modified TrisHCl buffer (10 mM Tris.HCl , pH 7.0, 10 mM NaCl, 3 mM MgCl₂, 30 mM sucrose). This was incubated on ice for 10 min and centrifuged (3000 RPM, 4° C.). The resulting pellet was resuspended in 1 mL of prechilled CaCl₂ buffer (10 mM Tris.HCl of pH 7.0, 10 mM NaCl, 3 mM MgCl₂, 30 mM sucrose, 10 mM CaCl₂). This was repeatedly centrifuged and washed with the CaCl2 buffer and the supernatant was discarded each time. The pellet was further purified by resuspending in a buffer containing 20 mM Tris-HCl of pH 7.9, 20% glycerol, 0.1 M KCl , and 0.2 mM EDTA and centrifuging at 14,000 rpm for 30 min at 4° C. The resulting pellet yielded the purified nuclear fraction and was resuspended in H₂O. The amount of protein in each fraction was analyzed by a BCA assay and the Pt content of each fraction was quantified by ICP-MS.

Mitochondrial Sub-fractionation: QD blended PLGA-b-PEG-TPP NPs (0.5 mg/mL with respect to NP) were internalized in PC3 cells (1.0×10⁶ cells/mL in 30 mL) for 6 h. After internalization, the mitochondria and the cytosol were isolated using a mitochondria isolation kit for mammalian cells. These fractions were further subfractionated. The freshly isolated PC3 mitochondria in PBS (1×) were incubated with protease inhibitor (0.125 mg/mL) and 0.6% digitonin for 10 min on ice. Immediately after incubation, the mitochondria were centrifuged at 10,000 g for 10 min at 4° C. The supernatant (SN-I) contained the outer mitochondrial membrane (OMM) fraction and the interstitial membrane space. The pellet was resuspended in 150 mmol/L KCl, protease inhibitor (0.125 mg/mL) and incubated on ice for 10 min. This was centrifuged at 10,000 g for 10 min at 4° C. The supernatant, which contained the mitochondrial matrix, was collected. To this, 50 μL of 1× cell lysis buffer (30 mM Tris-HCl, 0.1 mM EDTA, 20% w/v sucrose) was added. This was subsequently sonicated and centrifuged at 10,000 g for 15 min at 4° C. The supernatant (SN-II) containing the purified inner mitochondrial membrane (IMM) fraction and matrix was collected. SN-I and SN-II were centrifuged at 105,000 g for 60 min. The pellet from SN-I contained the OMM fraction and the supernatant contained the interstitial membrane space. The pellet from SN-II was resuspended in PBS containing Lubrol WX (0.5 mg/mL), 37% sucrose and incubated for 15 min on ice. This was once again centrifuged at 105,000 g for 60 min at 4° C. The pellet containing the IMM fraction and the supernatant contained the matrix was collected. The collected fractions were analyzed for Cd concentration by ICP-MS. A BCA assay was performed on all the fractions in order to calculate the Cd (ng)/protein (pg). The collected fractions were imaged on a Xenogen IVIS® Lumina system with 570 excitation wavelength and a Cy5.5 emission channel with an exposure time of 0.5 s.

Mito-stress Test Analysis: Different parameters of respiration: basal respiration, coupling efficiency, and spare respiratory capacity were investigated by using Seahorse XF-24 cell Mito Stress Test Kit. Prior to the assay, XF sensor cartridges were hydrated. To each well of an XF utility plate, 1 mL of Seahorse Bioscience calibrant was added and the XF sensor cartridges were placed on top of the utility plate, and kept at 37° C. incubator without CO2 for a minimum of 12 h. PC3, A2780-CP70, SH-SY5Y, and H9C2 (FIG. S18) cells were cultured in XF24-well cell culture microplates (Seahorse Bioscience) at a density of 2.5×10⁴ cells/well (except for H9C2, cell density of this cell line: 5×10⁴ cells/well) (0.32 cm2) in 200 μL growth medium and then incubated for 24 h at 37° C. in 5% CO₂ atmosphere. The cells were treated with Platin-M (10 μM), cisplatin (10 μM), DBCO-TPP (10 μM), empty-T-NPs, empty-NT-NPs, T-Platin-M-NPs, NT-Platin-M-NPs (10 μM with respect to Pt; ˜0.5 mg/mL for empty NPs) for 12 h at 37° C. in 5% CO₂ atmosphere. After 12 h, all but 50 μL of the culture medium was removed from each well and the cells were rinsed two times with 500 μL of XF stress test glycolysis optimization medium pre-warmed to 37° C. and finally 450 μL of glucose depleted optimization medium was added to each well and the plate was placed at 37° C. without CO₂ for 1 h prior to assay. Different parameters of respiration were calculated by subtracting the average respiration rates before and after the addition of the electron transport inhibitors oligomycin (1.0 μM), trifluorocarbonylcyanide phenylhydrazone or FCCP (1.0 μM), an ionophore that is a mobile ion carrier, and a mixture of antimycin-A (1.0 μM) which is a complex III inhibitor and rotenone (1.0 μM), a mitochondrial inhibitor that prevents the transfer of electrons from the Fe-S center in Complex I to ubiquinone. The parameters calculated included: basal respiration (baseline respiration minus antimycin-A post injection respiration), ATP turnover (baseline respiration minus oligomycin post injection respiration), maximal respiratory capacity (FCCP stimulated respiration minus antimycin-A post injection respiration) and reserve respiratory capacity (FCCP stimulated respiration minus baseline respiration). Test articles on each well had four replicates (data not shown).

In Vivo Biodistribution (bioD) and Pharmacokinetics (PK) of T-NPs: BioD and PK properties were determined using male Sprague Dawley rats weighing around ˜300 g.

Three rats per group, had T-QD-NPs injected via tail vein with ˜1 mL of T-NPs (23 mg/kg with respect to NPs, 81 μg/kg with respect to Cd) or saline. At varying time intervals, blood samples were collected in heparinized tubes and centrifuged in order to collect blood plasma. The percentage of QD was calculated by taking into consideration that blood constitutes 7% of body weight and plasma constitutes 55% of blood volume. The amount of Cd from the QD was calculated in the blood plasma by ICP-MS. After 24 h, the animals were sacrificed and the vital organs were collected. The collective urine and feces were also collected over a 24 h period. The overall bioD was calculated by analyzing the amount of Cd in each organ as well as the feces and urine by ICP-MS. Before analysis, the organs and feces were dissolved with PerkinElmer solvable (Product number: 6NE9100) for 24 h with gentle heating and shaking. The calculations for AUC, Cₘₐₓ, Tₘₐₓ, and C_{L} (t=0) were performed in the GraphPad Prism (Version 5.01). PK parameters were determined by fitting the data using a two compartmental model equation.

Cytotoxicity Analysis of Platin-M and Platin-M-NPs: The cytotoxicity of Platin-M, TPlatin-M-NPs, NT-Platin-M-NPs, and cisplatin was tested in PC3, A2780/CP70, SH-SY-5Y, and MSC by a (4,5-dimethylthizol-2-yl)-2,5-diphenyltetrazolium bromide (MTT) assay (data not shown). PC3 cells (2000 cells/well), A2780/CP70 cells (2000 cells/well), SHSY-5Y (2000 cells/well), and MSC (2000 cells/well) were plated on a 96 well plate and allowed to grow overnight. The media was changed and increasing concentrations of each formulation was added. For T-Platin-M-NPs, NT-Platin-M-NPs, the media was changed after 12 h and further incubated for an additional 60 h. The free drugs were incubated for 72 h without further media changes. After the given incubation time, MTT was added (5 mg/mL, 20 μL/well) and incubated for 5 h in order for MTT to be reduced to purple formazan. The media was removed and the cells were lysed with 100 μL of DMSO. In order to homogenize the formazan solution, the plates were subjected to 10 min of gentle shaking and the absorbance was read at 550 nm with a background reading at 800 nm with a plate reader. Cytotoxicity was expressed as mean percentage increase relative to the unexposed control ±SD. Control values were set at 0% cytotoxicity or 100% cell viability. Cytotoxicity data (where appropriate) was fitted to a sigmoidal curve and a three parameters logistic model used to calculate the IC₅₀, which is the concentration of chemotherapeutics causing 50% inhibition in comparison to untreated controls. The mean IC₅₀ is the concentration of agent that reduces cell growth by 50% under the experimental conditions and is the average from at least three independent measurements that were reproducible and statistically significant. The IC₅₀ values were reported at ±99% confidence intervals. This analysis was performed with GraphPad Prism (San Diego, U.S.A).

mtDNA-Pt and nDNA-Pt Adduct Quantification: The mitochondria and nuclei were isolated according to protocol mentioned before. These fractions were further fractionated in order to isolate mitochondrial and genomic DNA, respectively. For mitochondrial DNA (mtDNA), the freshly isolated mitochondria were re-suspended in 35 μL of mitochondrial lysis buffer. To this, 5 μL of the enzyme mix was added. This was incubated at 50° C. in water bath until the solution turned clear (˜1 h). To this, 100 μL of absolute ethanol was added and the resulting solution was incubated for 10 min at −20° C. The solution was then centrifuged at 14000 rpm for 5 min at room temperature. The resulting pellet was then purified by washing with 70% ethanol in nanopure H₂O. The resulting purified mtDNA was resuspended in tris-EDTA (TE) buffer. The resulting solution was quantified for the amount and purity of DNA by UV-Vis spectroscopy (260/280 nm) and the amount of Pt by ICP-MS. For genomic DNA (nDNA), the freshly isolated nuclei were re-suspended in 40 μL of cell lysis buffer. To this, 5 μL of the enzyme mix was added. This was incubated in a 50° C. water bath until the solution turned clear (˜1 h). To this, 100 μL of absolute ethanol was added and the resulting solution was incubated for 10 min at −20° C. The solution was then centrifuged at 14000 rpm for 5 min at room temperature. The resulting pellet was then purified by washing with 70% ethanol in nanopure H₂O. Reprecipitation with 70% ethanol in nanopure H₂O was performed until the ratio of the absorbances at 260 and 280 nm was ≦1.75 and ≧2.1. The resulting purified nDNA was resuspended in TE buffer. The resulting solution was quantified for the amount of DNA by UV-Vis spectroscopy (260/280 nm) and the amount of Pt by ICP-MS.

Animals. Animals were obtained from Harlan Laboratory and handled in accordance with “The Guide for the Care and Use of Laboratory Animals” of American Association for Accreditation of Laboratory Animal Care (AAALAC), Animal Welfare Act (AWA), and other applicable federal and state guidelines. All animal work presented here was approved by Institutional Animal Care and Use Committee (IACUC) of University of Georgia.

Statistics. All data were expressed as mean ±S.D (standard deviation). Statistical analysis were performed using GraphPad Prism® software v. 5.00 (GraphPad Software, Inc., CA). Comparisons between two values were performed using an unpaired Student t test. A one-way ANOVA with a posthoc Tukey test was used to identify significant differences among the groups.

TABLE 1
IC₅₀ (μM) Values of Platin-M and NPs

| | | | NT-Platin- | T-Platin- |
|---|---|---|---|---|
| | Cisplatin | Platin-M | M-NPs | M-NPs |
| PC3 | 13.1 ± 0.1 | 7.3 ± 0.8 | 3.1 ± 0.1 | 0.19 ± 0.01 |
| SH-SY5Y | 19 ± 4.7 | 3.4 ± 0.5 | 2.7 ± 0.6 | 1.1 ± 0.2 |
| A2780/ | 12.0 ± 2.8 | 0.74 ± 0.05 | 2.2 ± 0.7 | 0.14 ± 0.04 |
| CP70 | | | | |
| hMSC | 16.4 ± 0.5 | 2.4 ± 0.3 | 2.5 ± 0.3 | 0.81 ± 0.01 |

TABLE S1
Characterization of T-Platin-M-NPs

| % | | | Zetal | | |
|---|---|---|---|---|---|
| Platin-M | Z_{Average} | | Potential | % | % |
| Feed | (nm) | PDI | (mV) | Loading | EE |
| 0 | 51.7 ± 1.9 | 0.194 | 28.5 ± 1.56 | 0 | 0 |
| 10 | 52.7 ± 2.7 | 0.108 | 32.8 ± 3.1 | 6.3 ± 0.1 | 64.8 ± 0.9 |
| 20 | 51.1 ± 1.1 | 0.190 | 30.2 ± 0.2 | 10.1 ± 0.2 | 50.8 ± 0.8 |
| 30 | 50.1 ± 0.8 | 0.154 | 37.1 ± 0.3 | 14.0 ± 0.7 | 46.6 ± 2.4 |
| 40 | 50.6 ± 0.1 | .0184 | 34.5 ± 2.95 | 16.9 ± 0.4 | 42.3 ± 0.9 |
| 50 | 50.3 ± 0.6 | 0.157 | 35.8 ± 2.4 | 23.4 ± 0.8 | 46.9 ± 1.6 |

TABLE S2
Characterization of NT-Platin-M-NPs

| % | | | Zetal | | |
|---|---|---|---|---|---|
| Platin-M | Z_{Average} | | Potential | % | % |
| Feed | (nm) | PDI | (mV) | Loading | EE |
| 0 | 49.9 ± 0.9 | 0.156 | −22.1 ± 4.2 | 0 | 0 |
| 10 | 50.1 ± 0.9 | 0.152 | −31.6 ± 4.7 | 6.5 ± 0.2 | 65.9 ± 0.3 |
| 20 | 49.8 ± 1.2 | 0.159 | −33.8 ± 2.6 | 10.5 ± 1.4 | 50.9 ± 5.0 |
| 30 | 50.6 ± 1.3 | 0.156 | −31.1 ± 1.6 | 14.6 ± 2.4 | 50.7 ± 11 |
| 40 | 50.3 ± 2.5 | 0.175 | −27.8 ± 1.1 | 18.10 ± 0.02 | 45.3 ± 0.1 |
| 50 | 48.9 ± 1.0 | 0.184 | −24.5 ± 1.6 | 26.1 ± 0.5 | 52.2 ± 0.9 |

Thus, embodiments of MITOCHONDRIA-TARGETING PLATINUM(IV) PRODRUG are disclosed. One skilled in the art will appreciate that the nanoparticles and methods described herein can be practiced with embodiments other than those disclosed. The disclosed embodiments are presented for purposes of illustration and not limitation.

1. A compound of comprising:
a prodrug comprising a PT(IV) moiety, and
one or more mitochondria targeting moieties conjugated to the to a Pt(IV) moiety of the prodrug,
wherein reduction of Pt(IV) of the Pt(IV) moiety to Pt(II) releases the one or more mitochondria-targeting moieties from the compound and results in a Pt(II) therapeutic agent.

2. A compound according to claim 1, wherein the Pt(IV) prodrug comprises two mitochondria targeting moieties.

3. A compound of Formula I: 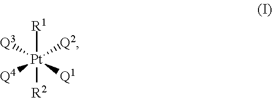
wherein
each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five- or six-membered platinocyclic rings;
R¹ is -(L¹)ₘ—(R³)ₙ;
R² is OH or -(L²)ₓ—(R⁴)_{y};
R³ is a mitochondria targeting moiety;
R⁴ is a conjugated cyclooxygenase inhibitor, a targeting moiety, a fluorophore, a glycolysis inhibitor, or a mitochondria acting therapeutic agent, wherein if R⁴ is a mitochondria targeting moiety, R³ and R⁴ are the same or different;
L¹ is a linker;
L² is a linker, wherein L¹ and L², if both are present, are the same or different;
m and x are independently zero or one; and
n and y are independently an integer greater than or equal to 1.

4. A compound according to claim 3, wherein when m=0, n=1 and when x=0, y=1.

5. A compound according to claim 3 or claim 11, wherein one or two of Q¹, Q², Q³, and Q⁴ are negatively charged ligands.

6. A compound according to claim 5, wherein two of Q¹, Q², Q³, and Q⁴ are negatively charged ligands.

7. A compound according to claim 5, wherein each of Q¹, Q², Q³, and Q⁴ that is a negatively charged ligand is selected from the group consisting of a halide, an alkoxide, an aryloxide, a carboxylate, and a sulfate.

8. A compound according to claim 7, wherein each of Q¹, Q², Q³, and Q⁴ that is a negatively charged ligand is a halide.

9. A compound according to claim 7, wherein each of Q¹, Q², Q³, and Q⁴ that is a negatively charged ligand is a chloride.

10. A compound according to claim 3, wherein one or two of Q¹, Q², Q³, and Q⁴ are neutral ligands.

11. A compound according to claim 10, wherein each of Q¹, Q², Q³, and Q⁴ that is a neutral ligand is independently selected from the group consisting of R₃N, wherein each R individually represents H or an organic group, wherein two or more R groups can optionally be joined to form one or more rings; and nitrogen-containing heteroaromatics.

12. A compound according to claim 11, wherein each of Q¹, Q², Q³, and Q⁴ that is a neutral ligand is independently R₃N.

13. A compound according to claim 10, wherein each of Q¹, Q², Q³, and Q⁴ that is a neutral ligand is NH₃.

14. A compound according to claim 3, wherein R⁴ is a mitochondria targeting moiety.

15. A compound of Formula IV: 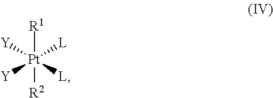
wherein
R¹ is -(L¹)ₘ—(R³)ₙ;
R² is OH or -(L²)ₓ—(R⁴)_{y};
R³ is a mitochondria targeting moiety;
R⁴ is a conjugated cyclooxygenase inhibitor, a targeting moiety, a fluorophore, a glycolysis inhibitor, or a mitochondria acting therapeutic agent, wherein if R⁴ is a mitochondria targeting moiety, R³ and R⁴ are the same or different;
L¹ is a linker;
L² is a linker, wherein L¹ and L², if both are present, are the same or different;
m and x are independently zero or one;
n and y are independently an integer greater than or equal to 1;
each Y independently represents a negatively charged ligand, wherein both Y ligands may optionally be joined to form a five- or six-membered platinocyclic ring; and
each L independently represents a neutral ligand, wherein both L ligands may optionally be joined to form a five- or six-membered platinocyclic ring.

16. A compound of Formula V, VI, or VII: 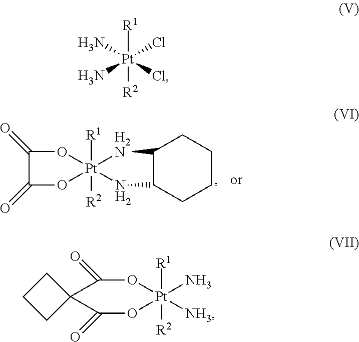
wherein one or both of R¹ and R² comprise a mitochondria targeting moiety.

17. A compound according to claim 16, wherein the compound is a compound of Formula (V):

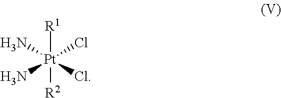

18. A compound according to claim 16, wherein both and R² comprise a mitochondria targeting moiety.

19. A compound according to claim 16, wherein one of R¹ and R² comprises a mitochondria targeting moiety and the other of R¹ and R² comprises a cyclooxygenase inhibitor, a targeting moiety other than a mitochondria targeting moiety, a fluorophore, a glycolysis inhibitor, or a mitochondria acting therapeutic agent, or is OH.

20. A compound according to claim 1, wherein at least one mitochondria targeting moiety comprises triphenyl phosophonium (TPP), a rhodamine cation, or a Szeto-Shiller peptide.

21. A compound according to claim 20, wherein at least one mitochondria targeting moiety comprises TPP.

22. A Platin-M compound:

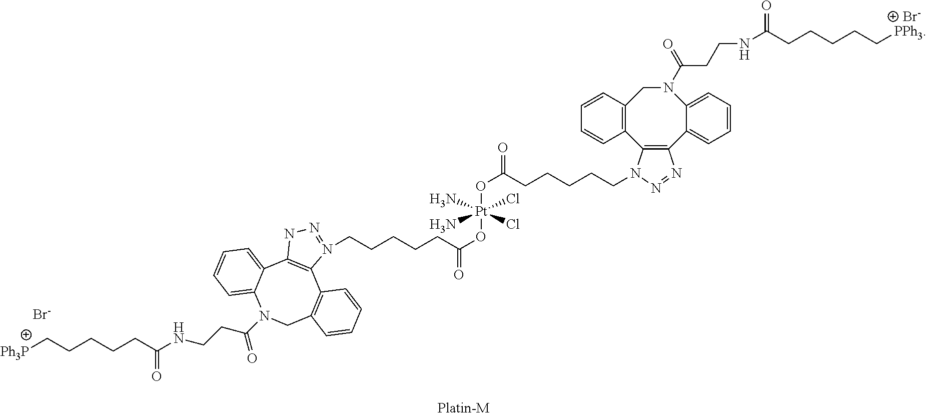

23. A nanoparticle comprising a compound according to claim 1.

24. A nanoparticle according to claim 23, wherein the nanoparticle further comprises a mitochondrial targeting moiety.

25. (canceled)

26. A method comprising administering a compound according to claim 1 to a subject.

27. A method for treating cancer in a subject in need thereof, comprising administering an effective amount of a compound according to claim 1 to the subject.

28. A method for treating a disease in a brain of a subject, comprising administering a compound according to claim 1 to the subject.

29. A method according to claim 28, wherein the compound is administered systemically.

30. A method for treating a disease of the mitochondria in a subject, the method comprising administering a compound according to claim 1 to the subject.

31. A compound according to claim 3, wherein at least one mitochondria targeting moiety comprises TPP.

32. A nanoparticle comprising a compound according to claim 3.

33. A nanoparticle according to claim 32, wherein the nanoparticle further comprises a mitochondrial targeting moiety.

34. A compound according to claim 15, wherein at least one mitochondria targeting moiety comprises TPP.

35. A nanoparticle comprising a compound according to claim 15.

36. A nanoparticle according to claim 35, wherein the nanoparticle further comprises a mitochondrial targeting moiety.

37. A compound according to claim 16, wherein at least one mitochondria targeting moiety comprises TPP.

38. A nanoparticle comprising a compound according to claim 16.

39. A nanoparticle according to claim 38, wherein the nanoparticle further comprises a mitochondrial targeting moiety.

40. A nanoparticle comprising a compound according to claim 22.

41. A nanoparticle according to claim 41, wherein the nanoparticle further comprises a mitochondrial targeting moiety.
